(19) United States
(12) Patent Application Publication
(10) Pub. No.: US 2010/0217933 A1
(43) Pub. Date: Aug. 26, 2010

(54) Allocation control program and allocation control device

(75) Inventors: Kazuichi Oe, Kawasaki-shi (JP); Tatsuo Kumano, Kawasaki-shi (JP); Yasuo Noguchi, Kawasaki (JP); Yoshihiro Tsuchiya, Kawasaki (JP); Kazutaka Ogihara, Kawasaki-shi (JP); Masahisa Tamura, Kawasaki (JP); Tetsutaro Maruyama, Kawasaki (JP); Takashi Watanabe, Kawasaki-shi (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/709,863

(22) Filed: Feb. 22, 2010

(30) Foreign Application Priority Data
Feb. 23, 2009 (JP) 2009-38749

(51) Int. Cl. G06F 12/00; G06F 12/02

(52) U.S. Cl. 711/114; 711/170; 711/E12.001; 711/E12.002

(57) ABSTRACT

An allocation control device divides the storage management devices into groups based on grouping factors. It generates group management information about each group based on the grouping factors corresponding to storage management devices belonging to the group. It obtains logical volume information about a subject logical volume to be allocated to the physical storage areas, the logical volume information indicating the capacity of the subject logical volume and a predicted capability value of the subject logical volume. It acquires the physical storage areas to which the subject logical volume is to be allocated, based on the logical volume information and the group management information. It selects one of the groups for which the maximum processing capability is higher than the predicted capability value of the subject logical volume. It allocates divisional areas of the subject logical volume to the physical storage areas in the selected group.

### CROSS-REFERENCE TO RELATED APPLICATIONS

This application is based upon and claims the benefit of priority of the prior Japanese Patent Application No. 2009-38749, filed on Feb. 23, 2009, the entire contents of which are incorporated herein by reference.

### FIELD

The embodiments discussed herein are related to a technique for allocating logical volumes to physical storage areas managed by a set of storage management devices.

### BACKGROUND

There have been distribution-type multi-node storage systems. In the conventional distribution-type multimode storage system, storage devices are divided and then distributed over a network and function in cooperation with one another, so as to achieve higher system performance and reliability. In such a multi-node storage system, virtual logical volumes are generated in accordance with requests from clients. The logical volumes are divided into specific divisional areas, and are allocated to the physical storage areas of storage devices.

In a regular allocation control operation, the divisional areas formed by dividing logical volumes are allocated in a round-robin fashion. In the round-robin fashion, the divisional areas are sequentially allocated to divisional physical storage areas formed by dividing the physical storage areas of each storage device. Through the allocation control operation, the divisional areas of the logical volumes are dispersedly distributed to all the storage devices that form the multi-node storage system.

In a case where data is duplicated in logical volumes, round-robin allocation control is performed under the condition that the secondary logical volumes should not be allocated to the storage devices to which the corresponding primary logical volumes are allocated (see Japanese Laid-open Patent Publication No. 2005-4681, for example).

However, it is not easy to maintain desired processing capability through the conventional allocation control.

An example of the round-robin allocation control is now described. FIG. 20 illustrates the conventional allocation control that is performed in a round-robin fashion.

A logical volume 0(950), a logical volume 1(951), and a logical volume 2(952) managed by access nodes AP0(940), AP1(941), and AP2(942), respectively, are virtual storage areas that function independently of one another. A disk node DP0(910) manages a disk #0(920) that is a physical storage area. Likewise, a disk node DP1(911) manages a disk #1(921), and a disk node DP2(912) manages a disk #2(922).

A control node CP(900) performs allocation control on the logical volumes. For example, the divisional areas L0-0, L0-1, L0-2, L0-3, L0-4, and L0-5 of the logical volume 0(950) are allocated to the disk #0(920), the disk #1(921), and the disk #2(922) in a round-robin fashion. In this manner, the logical volume 0(950) is divided and distributed to the disk nodes 910, 911, and 912. The same processing is performed on the divisional areas L1-0, L1-1, L1-2, L1-3, L1-4, and L1-5 of the logical volume 1(951), and the divisional areas L2-0, L2-1, L2-2, L2-3, L2-4, and L2-5 of the logical volume 2(952).

A large number of accesses might be made to the divisional area L1-0, for example. Since the divisional area L1-0 is allocated to the disk #0(920), the load on the disk node DP0(910) becomes larger due to the access concentration in the divisional area L1-0. Responses not only from the divisional area L1-0 but also from all the other slices of the disk #0(920) are degraded. The divisional areas L0-0, L0-3, L2-0, and L2-3 of the other logical volumes are also allocated to the disk #0(920), and therefore, the access processing for those areas delays.

As described above, the access concentration in the logical volume 1(951) leads to performance degradation such as response degradation of the other logical volumes 0(950) and 2(952). As a result, not only the processing capability of the logical volume having the access concentration but also the processing capability of all the other logical volumes are negatively impacted.

To maintain processing capability, the physical storage areas to be allocated to the logical volumes are divided among storage management devices. The number of storage management devices here is determined in accordance with the load on the logical volumes. In the conventional allocation control operation, however, logical volumes are evenly and statically divided among all the storage management devices.

### SUMMARY

An embodiment of the present invention provides an allocation control device that allocates logical volumes to physical storage areas managed by a set of storage management devices. Operations of the device include: dividing the storage management devices into groups based on grouping factors that contain at least one of information about the physical storage areas managed by each of the storage management devices, characteristics regarding performance of the storage management devices and corresponding storage devices, respectively, and information about rules for forming groups. The device generates group management information about each group based on the grouping factors corresponding to storage management devices belonging to the group, the group management information indicating maximum processing capability about the specific performance of the group. The device obtains logical volume information about a subject logical volume to be allocated to the physical storage areas, the logical volume information indicating the capacity of the subject logical volume and a predicted capability value of the subject logical volume with respect to the specific performance. The device acquires the physical storage areas to which the subject logical volume is to be allocated, based on the logical volume information and the group management information. The device selects one of the groups for which the maximum processing capability is higher than the predicted capability value of the subject logical volume. The device allocates divisional areas of the subject logical volume to the physical storage areas in the selected group.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a schematic view illustrating the allocation control to be implemented according to an embodiment of the present invention;

FIG. 2 illustrates an exemplary structure of a multi-node disk system in FIG. 1;

FIG. 3 illustrates an exemplary hardware structure of the control node in FIG. 2;

FIG. 4 illustrates an exemplary structure of a control node, logical volumes, and a set of disk nodes according to an embodiment of the present invention;

FIG. 5 illustrates an example of DP management information according to an embodiment of the present invention;

FIG. 6 illustrates exemplary structures of groups (according to an embodiment of the present invention) observed after the DP set is divided into groups;

FIG. 7 illustrates an example of group management information according to an embodiment of the present invention;

FIG. 8 illustrates the allocation state observed after an allocation process is performed based on the allocation rule 1 according to an embodiment of the present invention;

FIG. 9 illustrates the group management information (allocation information) observed in a case where the allocation process is performed based on the allocation rule 1 according to an embodiment of the present invention;

FIG. 10 illustrates the allocation state observed after an allocation process is performed based on the allocation rule 2 according to an embodiment of the present invention;

FIG. 11 illustrates the group management information (allocation information) observed in a case where the allocation process is performed based on the allocation rule 2 according to an embodiment of the present invention;

FIG. 12 illustrates a reallocation process performed (according to an embodiment of the present invention) in a case where a hot spot is formed;

FIG. 13 illustrates the group management information (allocation information) observed after a reallocation process that is performed (according to an embodiment of the present invention) due to a hot spot;

FIG. 14 illustrates an example of access characteristics information that is analyzed based on observation information according to an embodiment of the present invention;

FIG. 15 illustrates a reallocation process that is performed (according to an embodiment of the present invention) when the peak iops value exceeds the maximum iops value;

FIG. 16 illustrates the group management information observed after the reallocation process is performed (according to an embodiment of the present invention) due to the peak iops value higher than the maximum iops value;

FIG. 17 is a flowchart illustrating the procedures in the processing performed (according to an embodiment of the present invention) after the power supply starts;

FIG. 18 is a flowchart illustrating the procedures in the process to allocate slices to logical volumes according to an embodiment of the present invention;

FIG. 19 is a flowchart illustrating the procedures in a reallocation process according to an embodiment of the present invention; and

FIG. 20 illustrates conventional allocation control in a round-robin fashion.

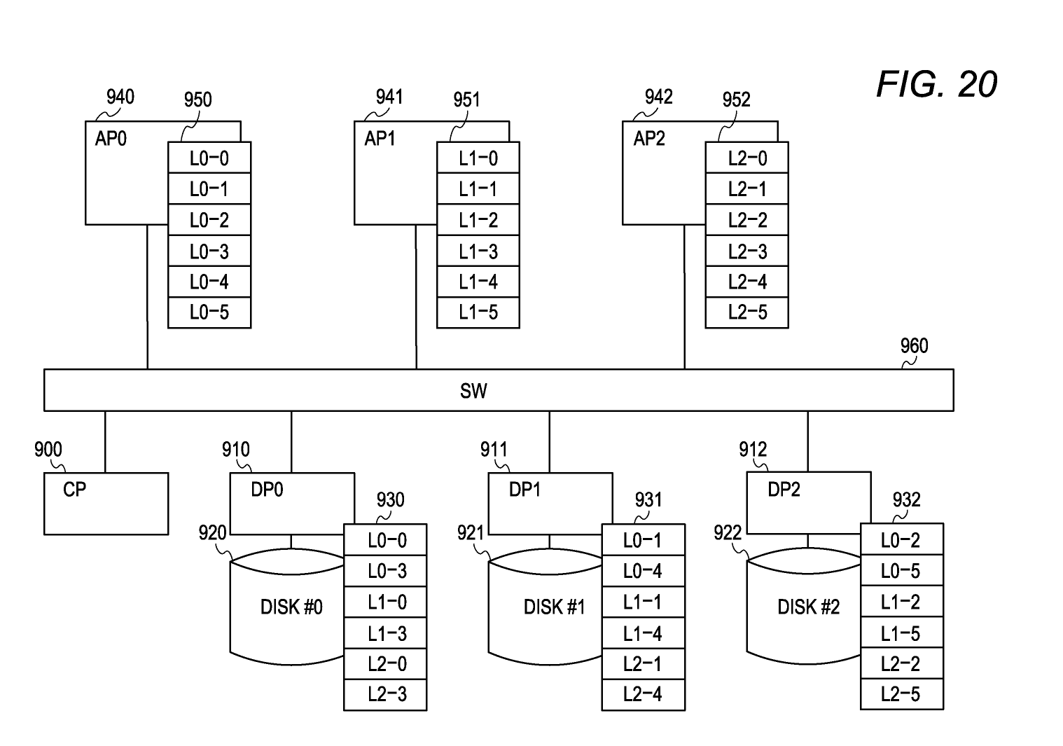

### DESCRIPTION OF EMBODIMENTS

The following is a description of embodiments of the present invention, with reference to the accompanying drawings. A brief summary of the allocation control implemented in the embodiments will be made first, and a specific description will follow.

Upon considering the Background Art, the inventors pondered consequences of the conventional allocation control operation that statically divides logical volumes among all the storage management devices. A consequence of such even static division is that there are a significant number of circumstances which exhibit diminished processing capability. By contrast, one or more embodiments of the present invention dynamically allocate logical volumes among the storage management devices in such manners as to exhibit greater processing capability across a variety of circumstances.

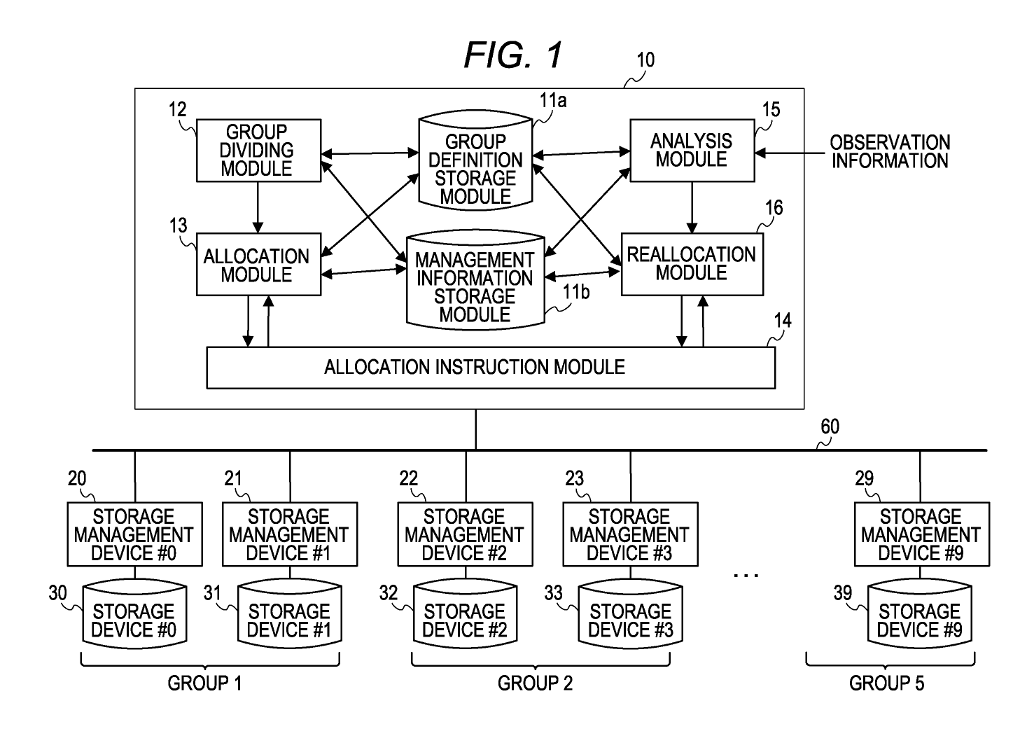

FIG. 1 is a schematic view illustrating the allocation control implemented in the embodiments.

Logical volumes are virtual storage areas that are managed by an access control device (not illustrated), and are allocated to physical storage areas by an allocation control device 10. The physical storage areas are located in a storage device #0(30) managed by a storage management device #0(20), a storage device #1(31) managed by a storage management device #1(21), a storage device #2(32) managed by a storage management device #2(22), a storage device #3(33) managed by a storage management device #3(23), . . . , and a storage device #9(39) managed by a storage management device #9(29). Hereinafter, each of those storage management devices and each of those storage devices will be referred to as a storage management device 2n and a storage device 3n, respectively, unless required to be specified. Areas formed by dividing the physical storage region of each storage device 3n are called “slices”, and the divisional areas corresponding to the slices in the logical volumes are called “logical slices”.

The allocation control device 10 is connected to the storage management devices 2n that manage the storage devices 3n having physical storage areas via a network 60, and performs processing to allocate slices of logical volumes. To perform the allocation, the allocation control device 10 includes a storage module formed with a group definition storage module 11a and a management information storage module 11b, a group dividing module 12, an allocation module 13, an allocation instruction module 14, an analysis module 15, and a reallocation module 16. Each of the modules has its processing function realized by a computer executing an allocation control program.

Grouping factors, including a rule for forming groups to be used to divide the storage management devices 2n into groups, are stored in the group definition storage module 11a. For example, the rule for forming groups defines requirements for forming groups, such as the number of storage management devices forming each one group, and the total capacity of the physical storage areas in each one group. Alternatively, a rule for forming groups based on the upper limit of the processing capability of each group (defining the iops, the throughput, the number of volumes, and the like of each group) may be generated. The iops (input output per second) represents the amount of reading and writing per unit time.

Storage management information about the storage management devices 2n and the storage devices 3n to be managed, and group management information about the groups generated are stored in the management information storage module 11b. The storage management information indicates the capacity of each of the physical storage areas of the storage devices 3b, the processing capability of each of the storage management devices 2n, and the like. The group management information indicates the identification information about the storage management devices forming the groups, the processing capability of the entire groups, and the like.

The group dividing module 12 reads the storage management information from the management information storage module 11b, and divides the storage management devices 2n into groups based on the group forming rule stored in the group definition storage module 11a. The storage management devices 2n and the storage devices 3n connected to the storage management devices 2n are inseparable. Accordingly, as the storage management devices 2n are divided into groups, the storage devices 3n are also divided into the groups. In each group, the identification information about the storage management devices 2n belonging to the group, and the information about the storage management devices 2n extracted from the storage management information are registered as the group management information, and are stored into the management information storage module 11b. In the group management information, the allocation information about the logical volumes allocated to the group is also registered.

The allocation module 13 reads the group management information from the management information storage module 11b, and, based on the group management information, selects the group to which a subject logical volume is to be allocated. The allocation module 13 selects at least such a group that the capacity of unallocated slices in the group is larger than the capacity of the logical slices of the subject logical volume. The allocation module 13 then allocates the subject logical volume to slices in the selected group, and issues an allocation instruction to the storage management device 2n managing the slices via the allocation instruction module 14. When the allocation is completed properly, the allocation information about the allocated logical volume is generated and is registered in the group management information.

The allocation instruction module 14 sends allocation instructions to the storage management devices 2n, in compliance with requests from the allocation module 13 and the reallocation module 16. The allocation instruction module 14 returns each response from the storage management devices 2n to the allocation module 13 or the reallocation module 16, whichever has made the corresponding request.

The analysis module 15 obtains observation information about the state of access to each storage device 3n observed by an observation module, and analyzes the observation information. The observation module may be provided in the allocation control device 10, or may be provided as an external device. For example, the observation module may be a packet analyzer that observes packets flowing in the network 60. The analysis module 15 obtains and analyzes the observation information supplied from the packet analyzer. The analysis module 15 then calculates observation values about certain performance such as the access processing capability of each storage management device 2n, and generates analysis information containing access characteristics and the like. For example, the analysis module 15 may obtain the iops observed in a logical volume by the packet analyzer over a predetermined period of time, and sets the iops as a performance index. Alternatively, the analysis module 15 may calculate the iops in each time slot, and analyze the tendency of access in each time slot. Further, the analysis module 15 may analyze packets of access requests, classify access patterns in accordance with the request size, and grasp the access pattern tendency. The analysis method is arbitrarily selected.

For each group, the reallocation module 16 performs dynamic reallocation. In particular, the reallocation module 16 compares the observation value about certain performance calculated by the analysis module 15 with the upper limit of the processing capability of the group set in the group management information. If the observation value is determined to be higher than the upper limit of the group, the reallocation module 16 performs reallocation of the logical volume. When the observation module detects an access concentration and is capable of sending a notification, the reallocation module 16 receives the notification and performs reallocation. In the reallocating process, the reallocation module 16 identifies the logical volume that has the higher measurement value about certain performance than the upper limit of the processing capability, or the group corresponding to the logical volume containing the logical slice at which the reported access concentration has occurred. Based on the group management information, the reallocation module 16 selects a new group to which the logical volume is to be allocated. The reallocation module 16 then reallocates part of or all of the logical volume to slices in the newly selected group. By allocating at least part of the logical volume to slices in the newly selected group, the amount of processing performed by each storage management device becomes more uniform, and by calculating the observation value prior to the reallocation, instances of the observation value exceeding the upper limit of the processing capability can be decreased if not prevented. Like the allocation module 13, the reallocation module 15 performs the reallocating process for each logical volume.

The operations to be performed by and the allocation control method to be implemented in the allocation control device 10 are now described.

When the system is started, information such as the rule for forming groups is set in the allocation control device 10. At the same time, the information about the storage management devices 2n, such as the peak iops and the access pattern of each storage management device 2n, is obtained. Those sets of information may be predicted values set by a manager. Alternatively, after the storage management devices 2n are activated, a notification of information such as the peak iops and the RAID type may be received from each storage management device 2n. Those sets of information are stored in the storage module. More specifically, the storage management information about the storage management devices 2n and the storage devices 3n is stored in the management information storage module 11b. The storage management information indicates the information about the capacity of each physical storage area of the storage devices 3n, the maximum iops of each storage management device 2n measured in advance, and the like. Grouping factors, e.g., including the rule for forming groups and information indicative of features of each group is stored in the group definition storage module 11a.

After the allocation control device 10 is activated, and the rule for forming groups and the storage management information are obtained, the storage management devices 2n are divided into groups, based on the information. For example, the rule for forming groups may specify that “each two storage management devices 2n are put into the same group”. In such a case, the storage management device #0(20) and the storage management device #1(21) are put into Group 1. Likewise, the storage management device #2(22) and the storage management device #3(23) are put into Group 2, and the storage management device #9(29) is put into Group 5, as illustrated in FIG. 1. The information about each of the groups is registered in the group management information. In this manner, groups are formed at the time of activation, and, after the information about each group is registered in the group management information, an allocating process is performed based on the group management information. When the allocation control device 10 is reactivated, the group management information is read out, and processing is performed based on the defined group formation.

When a subject logical volume is designated, the allocation module 13 starts an allocating process. The allocation module 13 obtains the logical volume information about the subject logical volume, and refers to the group management information to search for a group that can acquire physical storage areas for the subject logical volume. For example, the allocation module 13 selects a group that has physical storage areas that can acquire the capacity of the subject logical volume. If there is some other requirement, a group that satisfies the requirement is selected. When there is not a group detected, groups are combined, and the same procedures are repeated. In this manner, one or more groups are selected for the subject logical volume. The logical slices formed by dividing the subject logical volume are then initially allocated to slices in the selected group. The initial allocation of slices in the group is performed, e.g., in such a manner that logical slices are evenly distributed to the respective storage management devices in a round-robin fashion. For example, where Group 1 is allocated to a logical volume (logical volume A), the logical slices of the logical volume A are divided between the storage device #0(30) and the storage device #1(31). Likewise, where Group 2 is allocated to some other logical volume (logical volume B), the logical slices of the logical volume B are divided between the storage device #2(32) and the storage device #3(33). As will be described later, the initial allocation is subject to subsequent, dynamic reallocation if deemed appropriate.

Through the above procedures, the range of slices to which a logical volume is allocated in a process to allocate the logical volume to physical storage areas is limited within a group. In this manner, the access processing performed for a logical volume in a group can be reduced if not prevented from affecting the access processing for logical volumes in another group.

After a start of a system operation, the analysis module 15 analyzes actual access states. The analysis module 15 collects the observation information about each group, and analyzes the access state of each group. The analysis module 15 calculates the measurement value about certain performance of each group, and generates analysis information such as access characteristics. When the measurement value about certain performance is determined to be higher than the upper limit of the processing capability of the group defined by the group definition, the reallocation module 16 reallocates the logical volume. Alternatively, upon receipt of a notification issued when the observation module detects an error state, the reallocation module 16 may perform reallocation. In a reallocating process, the group that has the higher measurement value about certain performance than the upper limit of the processing capability or the group from which an access concentration is detected is identified. A new group to which the logical volume allocated to the identified group is to be reallocated is selected. Part of or all of the logical slices of the logical volume are moved to slices in the newly selected group. By allocating at least some of the logical slices to slices in the new group in this manner, the load of the storage management device performing the processing can be divided, and instances of the processing exceeding the upper limit of processing capability set in each group can be decreased if not prevented.

As described above, the range of slices to which a logical volume is to be allocated is limited within a group, so that the processing capability is not affected by the stages of logical volumes outside the group, and can be maintained as it is. After a start of the system operation, the actual access states are analyzed, and a check is made to determine whether more allocation of slices is desired to maintain the processing capability. If more allocation of slices is necessary, reallocation of the logical volume to slices is performed, so as to maintain the processing capability of the logical volume.

A multi-node disk system embodiment of present invention in which the storage devices are formed with disk devices is described in the following.

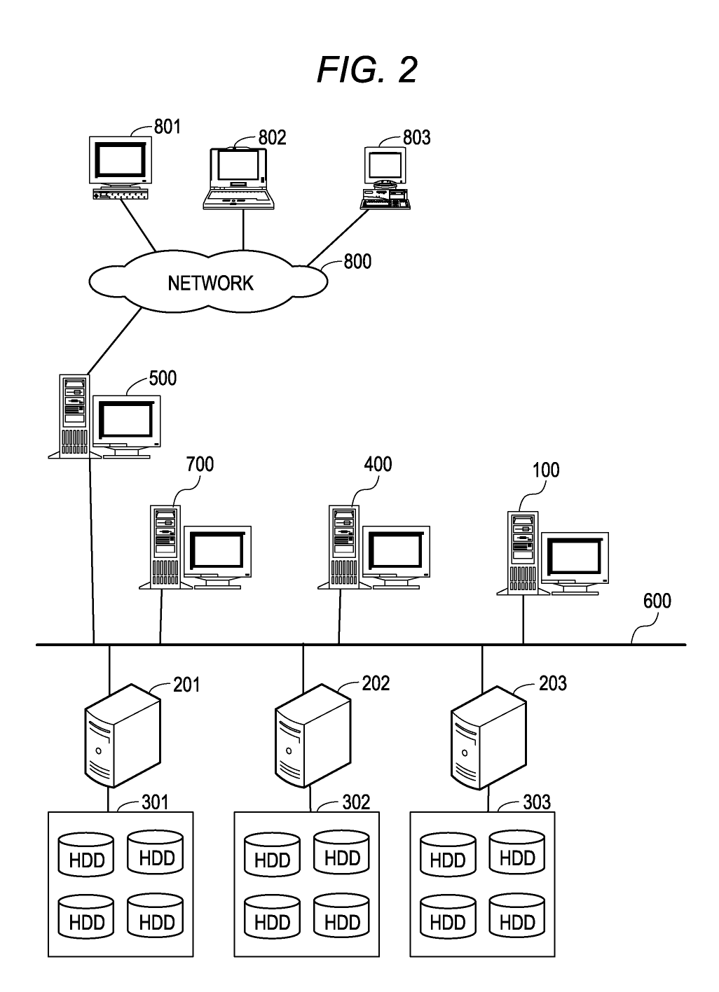

FIG. 2 illustrates an exemplary structure of a multi-node disk system of this embodiment.

In the multi-node disk system, a control node 100, disk nodes 201, 202, and 203, a packet analyzer 400, an access node 500, and a management node 700 are connected via a network 600.

The control node 100 is an allocation control device that performs allocation control to allocate logical slices formed by dividing virtual logical volumes to disks 301, 302, and 303 having physical storage areas.

The disk 301 is connected to the disk node 201, the disk 302 is connected to the disk node 202, and the disk 303 is connected to the disk node 203. The disk nodes 201, 202, and 203 function as the storage management devices, and the disks 301, 302, and 303 function as the storage devices. Hard disk drives (HDD) forming physical storage areas are mounted in the disk 301. Each of the disks 302 and 303 has the same structure as the disk 301. The physical storage areas of the disks 301, 302, and 303 are divided into slices, and are managed by the disk nodes 201, 202, and 203, respectively. The slices include the areas for storing the data about logical slices, and the areas for storing the management information about the slices (hereinafter referred to as the metadata). The disk nodes 201, 202, and 203 may be computers each having a so-called IA (Intel Architecture), for example. Based on the metadata, stored in the connected disks 301, 302, and 303, the disk nodes 201, 202, and 203 provide slice data to terminal devices 801, 802, and 803 via the access node 500.

The packet analyzer 400 is the observation module that acquires packets flowing in the network 600 and generates the observation information. With a detection condition being set in advance in case of an access concentration that exceeds a threshold value, occurrence of a phenomenon can be reported when the phenomenon satisfying the condition is detected.

The terminal devices 801, 802, and 803 are connected to the access node 500 via a network 800. The access node 500 recognizes the storage locations of the data managed by the disk nodes 201, 202, and 203. In response to requests from the terminal devices 801, 802, and 803, the access node 500 accesses the data in the disk nodes 201, 202, and 203.

The management node 700 manages the entire multi-node disk system. Also, in accordance with instructions from the manager, the management node 700 notifies the control node 100 of logical volume allocation instructions.

Next, the hardware structure of each node is described, with the control node 100 taken as an example.

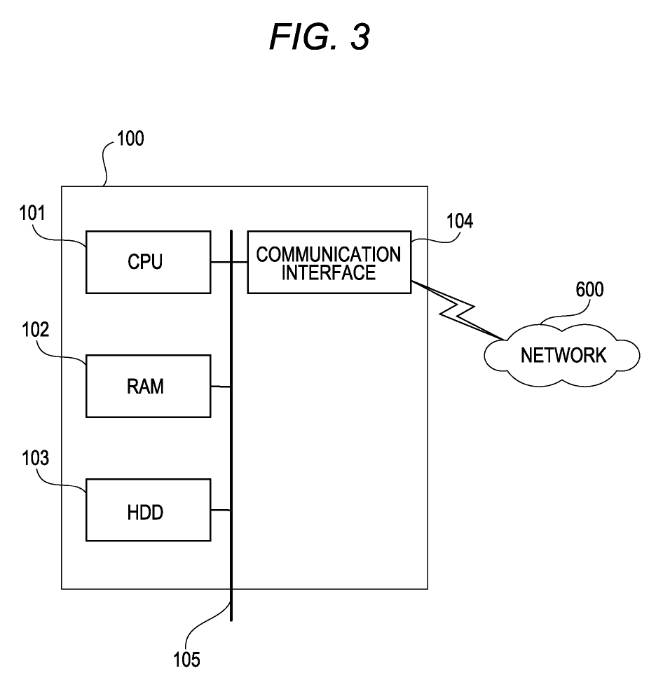

FIG. 3 illustrates an exemplary hardware structure of the control node in FIG. 2.

The control node 100 has its entire device controlled by a CPU (Central Processing Unit) 101. A RAM (Random Access Memory) 102, an HDD 103, and a communication interface 104 are connected to the CPU 101 via a bus 105.

At least the OS and application programs to be executed by the CPU 101 are partially stored in the RAM 102 in a temporary manner. Also, various kinds of data necessary for the processing to be performed by the CPU 101 are stored in the RAM 102. The OS and application programs are stored in the HDD 103. The communication interface 104 is connected to the network 600. The communication interface 104 exchanges data with the other computers forming the multi-node disk system, such as the disk nodes 201, 202, and 203, the packet analyzer 400, the access node 500, and the management node 700, via the network 600.

Although the hardware structure of the control node 100 is illustrated in FIG. 3, each of the disk nodes and the access node has the same hardware structure as the control node 100.

A specific example of the allocation control on logical volumes in the multi-node disk system having the above structure is now descried.

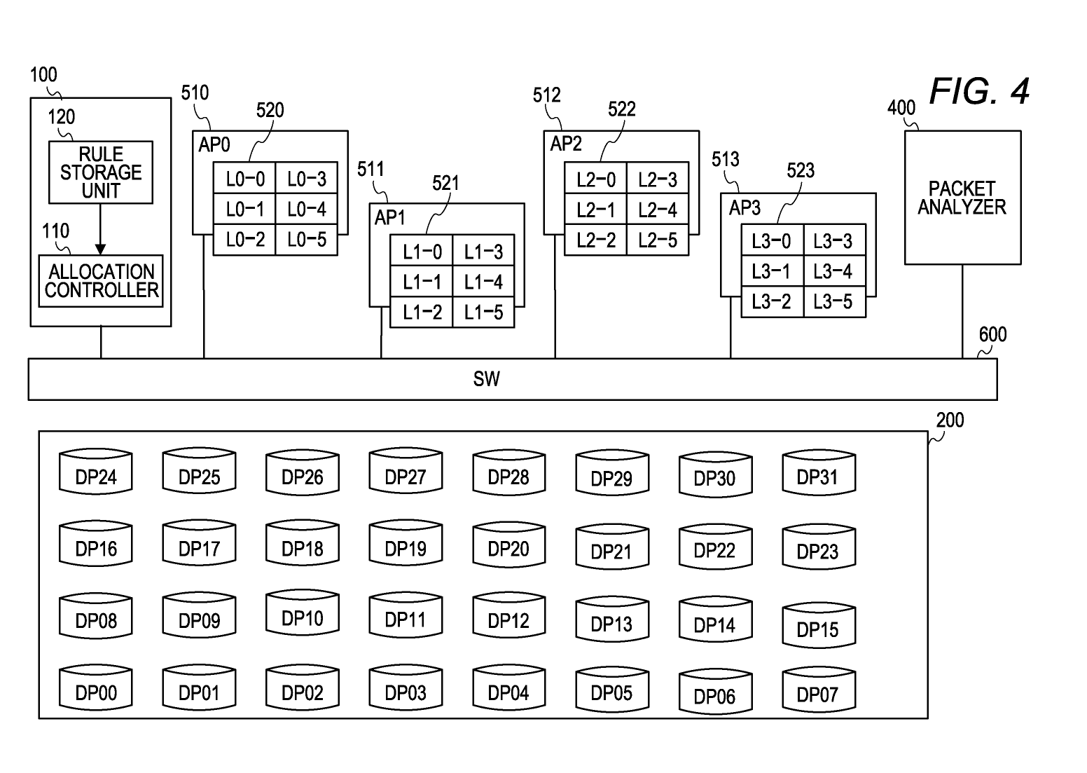

FIG. 4 illustrates exemplary structures of the control node, logical volumes, and a set of disk nodes. In FIG. 4, the same components as those in FIG. 2 are denoted by the same reference numerals as those used in FIG. 2, and explanation thereof is omitted herein.

The control node 100 includes an allocation controller 110 and a rule storage unit 120. The allocation controller 110 includes the components illustrated in FIG. 1, and controls the allocation of logical volumes 520, 521, 522, and 523 to a set of disk nodes (“DP”) 200, based on the group forming rule and the like. The rule storage unit 120 stores the rule for forming DP groups that are defined in advance, the allocation and reallocation rules, and the like. When a failure is detected from a DP by a management unit (not illustrated), the control node 100 performs slice management processing by restoring the data stored in the broken slice.

The DP set 200 includes DPs representing the combinations of the disk nodes 201, 202, 203, . . . and the disks 301, 302, 303, . . . . In this example, the thirty-two DPs of DP 00 to DP 31 form the DP set 200.

Access nodes AP0(510), AP1(511), AP2(512), and AP3(513) manages the logical volumes that function independently of one another. Here, the access node AP0(510) manages the logical volume LVOL0(520), the access node AP1(511) manages the logical volume LVOL1(521), the access node AP2(512) manages the logical volume LVOL2(522), and the access node AP3(513) manages the logical volume LVOL3(523). Each of the logical volumes is divided into six, and the slice numbers of 0 to 5 are allotted to the six portions. In the following description, each logical slice is represented by the identifier (one of L0 to L3) of the logical volumes and the slice number. The logical slices of the logical volume LVOL0(520) are represented by L0-0, L0-1, L0-2, L0-3, L0-4, and L0-5. The logical slices of the logical volume LVOL1(521) are represented by L1-0, L1-1, L1-2, L1-3, L1-4, and L1-5. The logical slices of the logical volume LVOL2(522) are represented by L2-0, L2-1, L2-2, L2-3, L2-4, and L2-5. The logical slices of the logical volume LVOL3(523) are represented by L3-0, L3-1, L3-2, L3-3, L3-4, and L3-5. Although one logical volume is allocated to one access node in this example, the number of logical volumes to be managed by one access node can be arbitrarily set.

FIG. 4 illustrates the state observed prior to a start of allocation, and the logical slices of the logical volumes LVOL0(520), LVOL1(521), LVOL2(522), and LVOL3(523) have not yet been allocated to slices in the set of DPs 200 in this state.

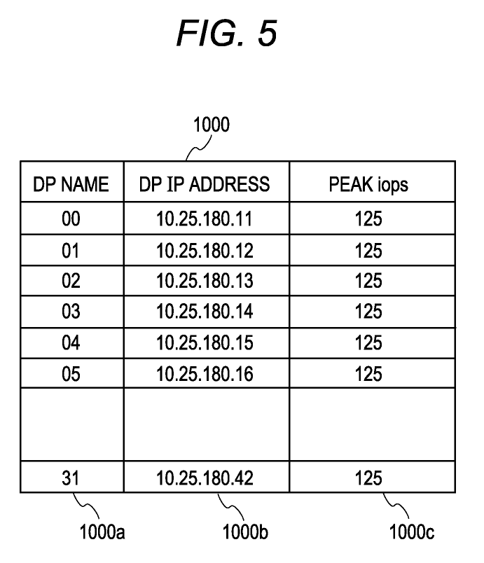

FIG. 5 illustrates an example of the DP management information.

The DP management information 1000 is the management information about the DPs forming the DP set 200, and is obtained from each DP prior to start-up.

The DP management information 1000 has the information item columns of a DP name column 1000a, a DP IP address column 1000b, and a peak iops column 1000c.

The numbers uniquely allotted to the respective DPs are registered as the information for identifying the respective DPs in the DP name column 1000a.

The IP addresses of the disk nodes are registered in the DP IP address column 1000b. Communications with the disk nodes are performed with the use of those IP addresses.

The maximum iops values in accordance with the numbers of accesses that can be processed by the respective DPS are registered in the peak iops column 1000c. The peak iops values are measured in advance, or are registered beforehand by the manager.

On the top row of the DP management information 1000, the IP address “10.25.180.11” and the peak iops “125” are registered for “DP 00”.

The DP management information 1000 is merely an example, and various kinds of information may be registered as needed. If the memory capacities and the models of the respective DPs are the same, it is not necessary to record the memory capacities and the models. However, if the memory capacities and the models are different, the information about the capacity and the model of each DP is registered.

Next, the DP group forming process is described.

The DP group formation in the DP set 200 is performed based on the DP management information 1000 illustrated in FIG. 5 and the group forming rule that is defined in advance.

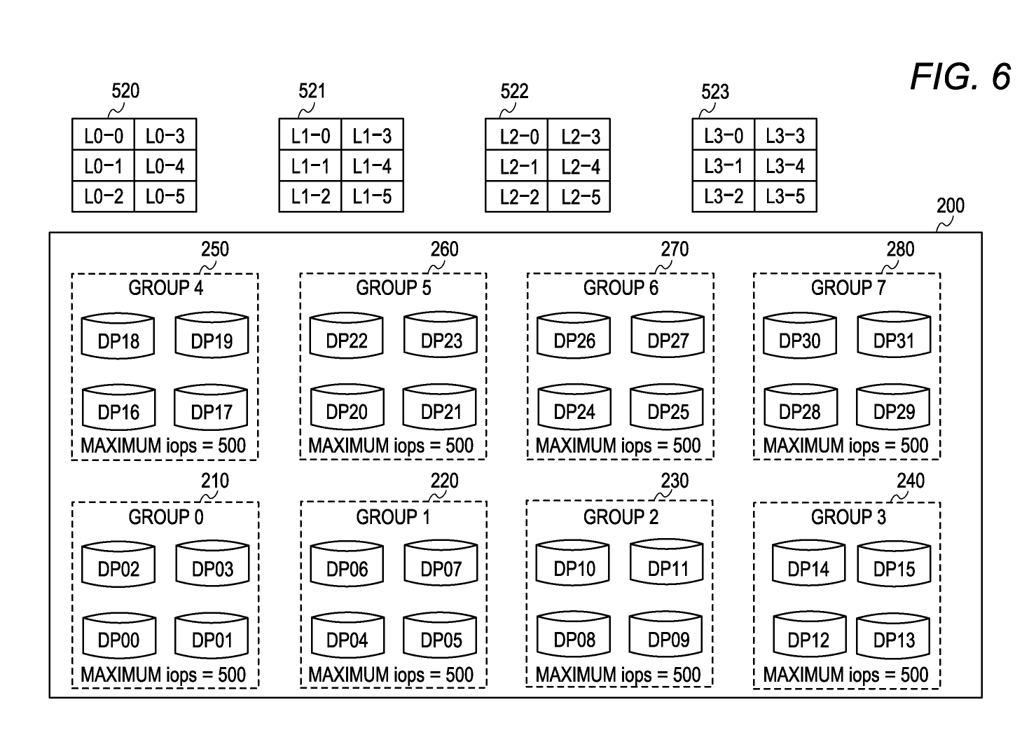

FIG. 6 illustrates exemplary group structures formed after the group formation is performed in the DP set.

FIG. 6 illustrates the state observed after the group formation is performed in the DP set 200 in the multi-node disk system illustrated in FIG. 4. In FIG. 6, the control node 100, the access nodes 510, 511, 512, and 513, and the packet analyzer 400 are not illustrated, for simplification of the drawing.

Here, the group forming rule specifies, e.g., that “each four DPs form one group”.

Accordingly, with DP 00 being the first one, the DPs belonging to the DP set 200 are sequentially divided into four-DP groups. As illustrated in FIG. 6, the DP 00 to the DP 03 form a DP group 0(210), the DP 04 to the DP 07 form a DP group 1(220), the DP 08 to the DP 11 form a DP group 2(230), the DP 12 to the DP 15 form a DP group 3(240), the DP 16 to the DP 19 form a DP group 4(250), the DP 20 to the DP 23 form a DP group 5(260), the DP 24 to the DP 27 form a DP group 6(270), and the DP 28 to the DP 31 form a DP group 7(280). In this manner, the DP set 200 is divided into eight groups each consisting of four DPs.

The maximum iops of each DP group is determined by reading the peak iops values of the DPs in the DP group from the DP management information 1000, and adding up the peak iops values. For example, the peak iops values of the DP 00 to the DP 03 belonging to the DP group 0(210) are all “125”, as illustrated in FIG. 5. Accordingly, the maximum iops of the DP group 0(210) is “500”, which is the total sum of the peak iops values. The maximum iops of each of the other DP groups is also calculated in this manner. At the same time of the group formation, the group management information for managing the DP groups is generated.

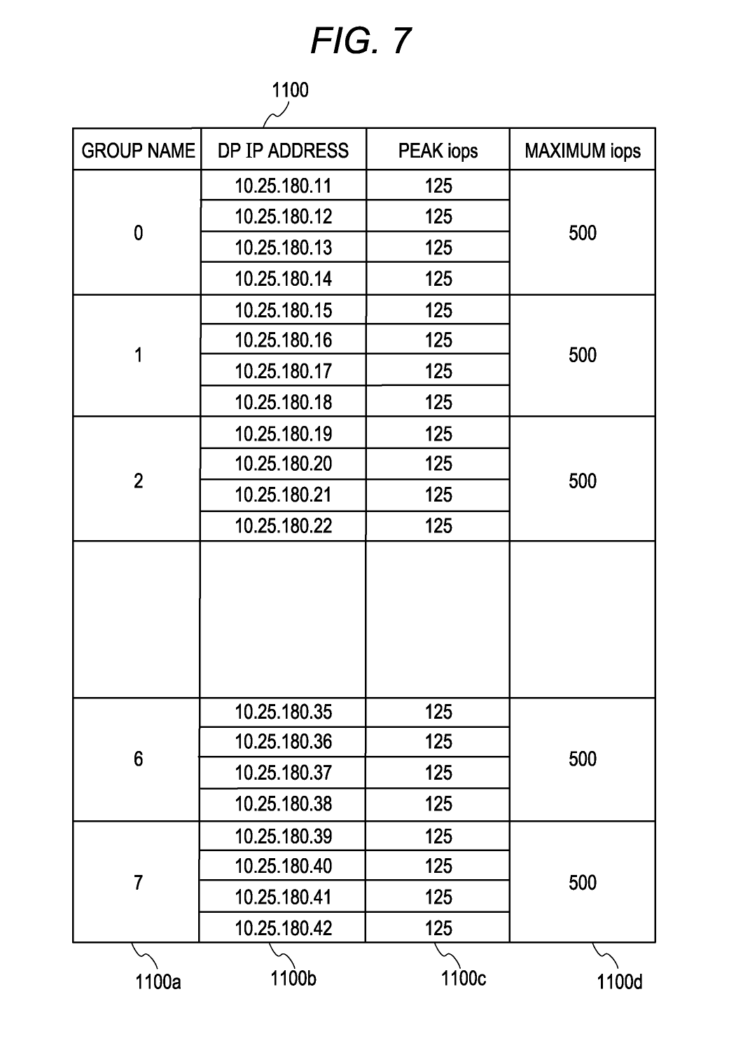

FIG. 7 illustrates an example of the group management information.

The group management information 1100 is the group management information for managing the DP groups illustrated in FIG. 6, and has the information item columns of a group name column 1100a, a DP IP address column 1100b, a peak iops column 1100c, and a maximum iops column 1100d.

To identify each generated DP group, the identification numbers uniquely allotted to the respective DP groups are registered in the group name column 1100a. In the group name column 1100a, “0” to “7” represent the DP group 0 to the DP group 7, respectively.

In the DP IP address column 1100b, the IP address of the DPs are registered as the identification information for identifying the DPs divided into the groups illustrated in the group name column 1100a.

The peak iops values of the DPs are registered in the peak iops column 1100c. The appropriate information extracted from the DP management information 1100 is stored in each of the DP IP address column 1100b and the peak iops column 1100c.

The maximum processing capability of each corresponding DP group is registered in the maximum iops column 1100d. As described above, each maximum iops value is calculated by adding up the peak iops values of the DPs belonging to each corresponding DP group.

In this manner, the structure and the maximum processing capability of each DP group is set in the group management information 1100.

Although the group forming rule specifies that four DPs form one DP group in the above example, the group forming rule can be arbitrarily set by the manager.

For example, the group forming rule may be set to specify that a desired capacity forms one DP group. In such a case, the memory capacities of the DPs are added up based on the DP management information, with the DP 00 being the first one. When the total memory capacity reaches the desired capacity, one group is formed. The same processing is repeated on the next DP, and other DP groups are formed. Also, the rule may be set to specify that DPs of the same model form one group. Further, the rule may be set to specify that DP groups each satisfying a reference maximum iops are formed.

After the DP groups are formed in the above manner, the allocation controller 110 starts an allocation process, upon receipt of a logical volume allocation instruction via the management node 700. A rule for allocation is defined in advance, and the allocation controller 110 performs the allocation process based on the rule for allocation.

First, a case where an allocation process is performed based on an allocation rule specifying, e.g., that “each logical volume is allocated to slices in a DP group to which any other logical volume is not allocated” (the allocation rule 1) is described.

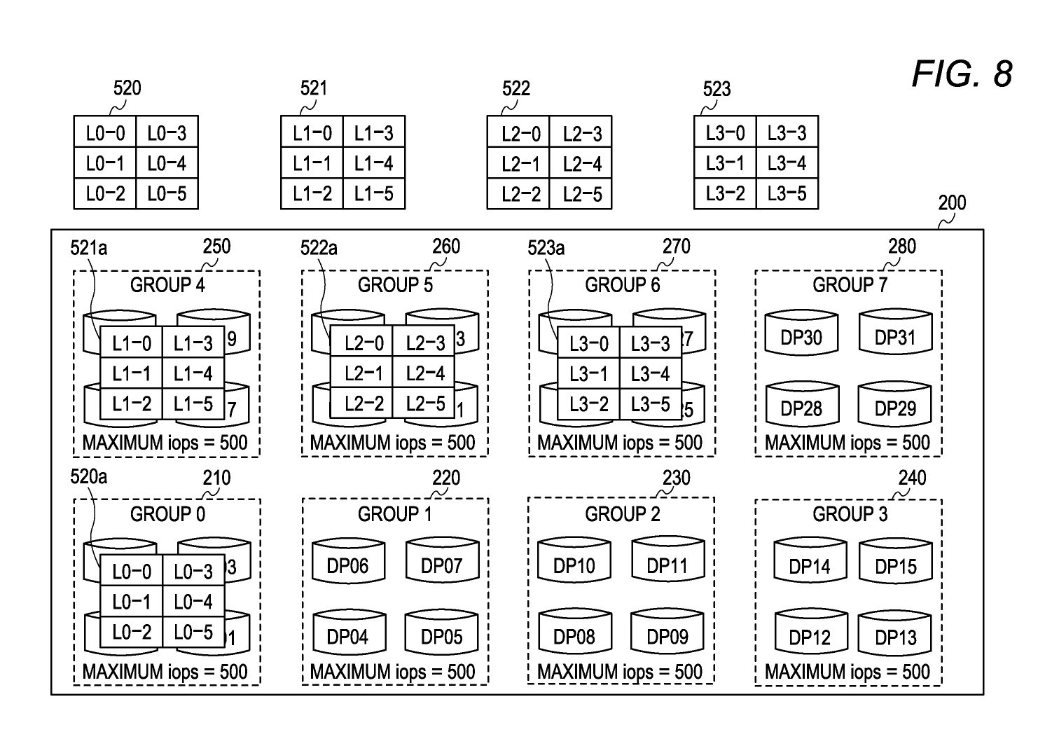

FIG. 8 illustrates the allocation state observed when an allocation process is performed based on the allocation rule 1.

Based on the allocation rule 1, the allocation controller 110 selects and allocates different DP groups to the logical volumes LVOL0(520), LVOL1(521), LVOL2(522), and LVOL3(523). In the example illustrated in FIG. 8, the DP group 0(210) is allocated to the logical volume LVOL0(520), the DP group 4(250) is allocated to the logical volume LVOL1(521), the DP group 5(260) is allocated to the logical volume LVOL2(522), and the DP group 6(270) is allocated to the logical volume LVOL3(523).

A slice allocation process then follows to allocate the logical slices of the logical volumes to slices in the DP groups allocated to the logical volumes. As for the logical volume LVOL0(520) having the DP group 0(210) allocated thereto, the logical slices L0-0, L0-1, L0-2, L0-3, L0-4, and L0-5 are divided among the DP 00, the DP 01, the DP 02, and the DP 03 that form the DP group 0(210). In a round-robin fashion, the logical slice L0-0 of the logical volume 520a is allocated to the DP 00, the logical slice L0-1 is allocated to the DP 01, the logical slice L0-2 is allocated to the DP 02, the logical slice L0-3 is allocated to the DP 03, the logical slice L0-4 is allocated to the DP 00, and the logical slice L0-5 is allocated to the DP 01. In this manner, the logical volume LVOL0(520) is allocated to the slice set 520a evenly divided among the DPs in the DP group 0(210).

Likewise, the logical volume LVOL1(521) is allocated to a slice set 521a evenly divided among the DPs in the DP group 4(250). The logical volume LVOL2(522) is allocated to a slice set 522a evenly divided among the DPs in the DP group 5(260). The logical volume LVOL3(523) is allocated to a slice set 523a evenly divided among the DPs in the DP group 6(270).

The above allocation state is registered as the allocation information in the group management information.

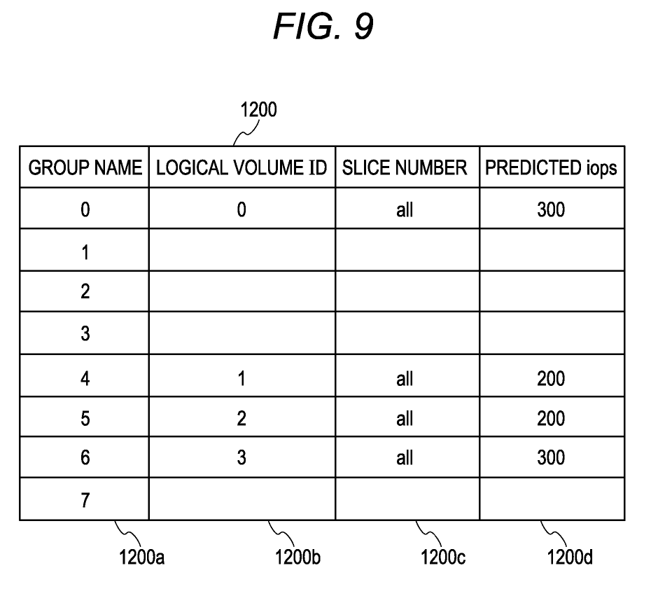

FIG. 9 illustrates the group management information (the allocation information) formed in a case where the allocation process is performed based on the allocation rule 1.

The group management information (the allocation information) 1200 indicates the allocation information added to the group management information 1100 illustrated in FIG. 7. The group management information (the allocation information) 1200 has the information item columns of a group name column 1200a, a logical volume ID column 1200b, a slice number column 1200c, and a predicted iops column 1200d.

As in the group name column 1100a of the group management information 1100, the identification numbers of the DP groups are registered in the group name column 1200a.

The IDs (the identification numbers) of the logical volumes allocated to the DP groups are registered in the logical volume ID column 1200b. Here, “0” to “3” represent the logical volumes LVOL0 to LVOL3, respectively.

The identification numbers of the logical slices allocated to the DP groups are registered in the slice number column 1200c. Here, “0” to “5” represent the logical slice 0 to the logical slice 5, respectively. In this column, each “all” refers to all the logical slices of a logical volume that are allocated to the group.

The predicted iops values of the logical volumes obtained from the logical volume information are registered in the predicted iops column 1200d. For example, according to the top row, “all slices (“all”)” of the logical volume “LVOL1” are allocated to the “DP group 0”, and the predicted iops value of the logical volume is “300”. The same applies to the DP groups 4, 5, and 6.

As described above, based on the allocation rule 1 specifying that “each logical volume is allocated to slices in a DP group to which any other logical volume is not allocated”, the logical volumes are allocated to different DP groups from one another. Accordingly, even if the access load of one of the logical volumes becomes too large, and a response delay occurs, the logical volume does not affect the other logical volumes, and maintains the processing capability.

Furthermore, the slice allocation of a logical volume is limited within the selected group. Accordingly, the DP groups unallocated to the logical volumes can be stopped, and the power consumption can be reduced.

Based on the allocation rule 1, however, the access load predicted for a logical volume might be smaller than the upper limit of the processing capability of the corresponding DP group, and so an opportunity for yet greater efficiency presents itself.

An allocation rule 2 is designed to take advantage of this opportunity and perform yet more efficient allocation control.

Next, a case where an allocation process is performed based on an allocation rule (the allocation rule 2) specifying, e.g., that “while the iops value desired for each logical volume is acquired, allocation of logical volumes to slices of a DP group is performed” is described.

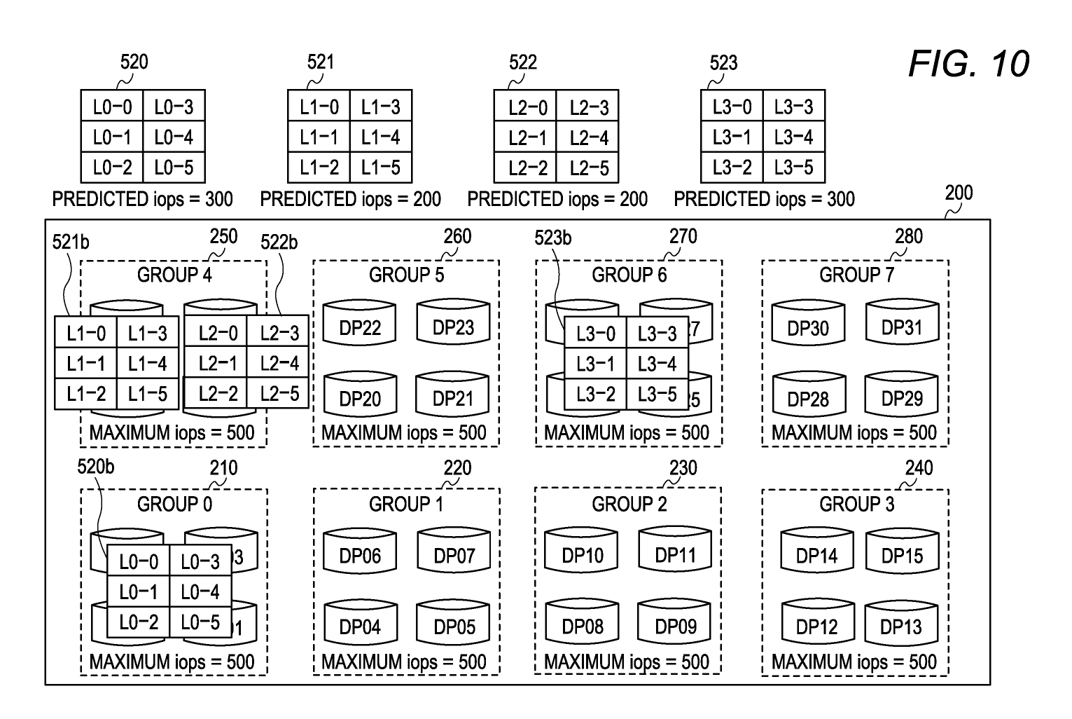

FIG. 10 illustrates the allocation state observed when an allocation process is performed based on the allocation rule 2.

Based on the allocation rule 2, the allocation controller 110 obtains predicted iops values as the predicted values of accesses made to the respective logical volumes. The predicted iops values are defined in advance as the logical volume information by a manager or the like who designates a subject logical volume to be subjected to allocation processing. The allocation controller 110 compares the obtained predicted iops value of each logical volume with the maximum iops value of each DP group registered in the group management information 1100. If the maximum iops value of a DP group is higher than the predicted iops value of a logical volume, the DP group is elected, and is allocated to the logical volume.

In the example illustrated in FIG. 10, the predicted iops value of the logical volume LVOL0(520) is “300”, the predicted iops value of the logical volume LVOL1(521) is “200”, the predicted iops value of the logical volume LVOL2(522) is “200”, and the predicted iops value of the logical volume LVOL3(523) is “300”.

The predicted iops value of the logical volume LVOL0(520) is “300”, which is not larger than the maximum iops value “500” of the DP group 0(210). Accordingly, the DP group 0(210) is allocated to the logical volume LVOL0(520). Where the logical volume LVOL0(520) is allocated to the DP group 0(210), there is a margin of 200 to reach the maximum iops value.

The next logical volume LVOL1(521) has the predicted iops value of “200”. When the logical volume LVOL1(521) is allocated to the DP group 0(210), the total predicted iops value of the logical volume LVOL0(520) and the logical volume LVOL1(521) is “500”. Therefore, another DP group is selected and allocated. In the example illustrated in FIG. 10, the DP group 4(250) is allocated. Where the logical volume LVOL1(521) is allocated to the DP group 4(250), there is a margin of 300 to reach the maximum iops.

The next logical volume LVOL2(522) has the predicted iops value of “200”. When the logical volume LVOL2(522) is allocated to the DP group 4(250), the total predicted iops value of the logical volume LVOL1(521) and the logical volume LVOL2(522) is “400”, which is lower than the maximum iops “500” of the DP group 4(250). Accordingly, the logical volume LVOL2(522) is allocated to the DP group 4(250).

Likewise, the DP group 6(270) is selected for the next logical volume LVOL3(523).

In this manner, the DP group 0(210) is selected for the logical volume LVOL0(520), the DP group 4(250) is selected for the logical volume LVOL1(521), the DP group 4(250) is also selected for the logical volume LVOL2(522), and the DP group 6(270) is selected for the logical volume LVOL3(523) in the example illustrated in FIG. 10.

The allocation to slices in each selected DP group is performed in the same manner as in the example illustrated in FIG. 8 where the allocation is preformed based on the allocation rule 1. Accordingly, the logical volume LVOL0(520) is evenly divided in the DP group 0(210), and is allocated to the slice set 520b. The logical volume LVOL1(521) is allocated to the slice set 521b in the DP group 4(250), and the logical volume LVOL2(522) is allocated to the slice set 522b in the DP group 4(250). The logical volume LVOL3(523) is evenly divided in the DP group 6(270), and is allocated to the slice set 523b.

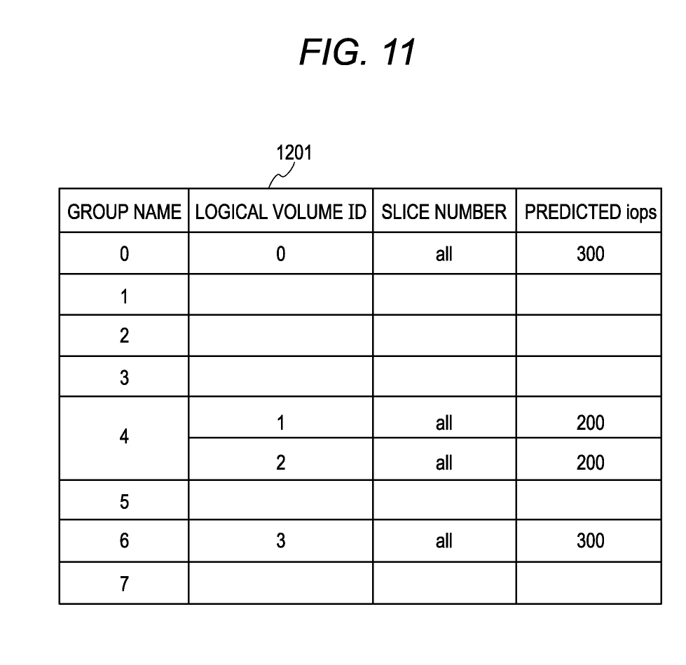

FIG. 11 illustrates the group management information (the allocation information) formed in a case where an allocation process is performed based on the allocation rule 2.

The group management information (the allocation information) 1201 has the same structure as the group management information 1200 illustrated in FIG. 9, and illustrates the state observed after an allocation process is performed based on the allocation rule 2.

The row corresponding to the DP group 4 indicates that the logical volumes “LVOL1” and “LVOL2” are allocated to the “DP group 4”.

As described above, based on the allocation rule 2 specifying that “while the iops value desired for each logical volume is acquired, allocation of logical volumes to slices of a DP group is performed”, allocation is performed while the capacity to cope with the access load of each logical volume is acquired. Accordingly, efficient allocation can be performed, and the processing capability of the logical volumes is maintained. Even if the access load of one of the logical volumes becomes too large, and a response delay occurs, the logical volume does not affect the logical volumes allocated to the other DP groups. Thus, the logical volumes allocated to the other DP groups can maintain their processing capability.

The allocation processes based on the allocation rule 1 or the allocation rule 2 have been described so far. However, the allocation rules 1 and 2 are merely examples, and a manager can arbitrarily set an allocation rule. A different allocation rule may set for each logical volume.

After an actual system operation is started, an unpredicted situation might occur in the course of the operation. For example, a large number of accesses to a certain area might be made, and response delays might occur. In the following description, such an area to which a large number of accesses are made is called a “hot spot”. The packet analyzer 400 monitors the network 600, and checks for hot spots. When a hot spot is detected, information such as the identification number of the logical volume or slice at which the hot spot is detected, and the size (the iops) of the hot spot, is sent to the control node 100.

Upon receipt of the notification of the hot spot, the allocation controller 110 searches for the DP group in which the hot spot is detected, based on the notification, and identifies the DP group and slice.

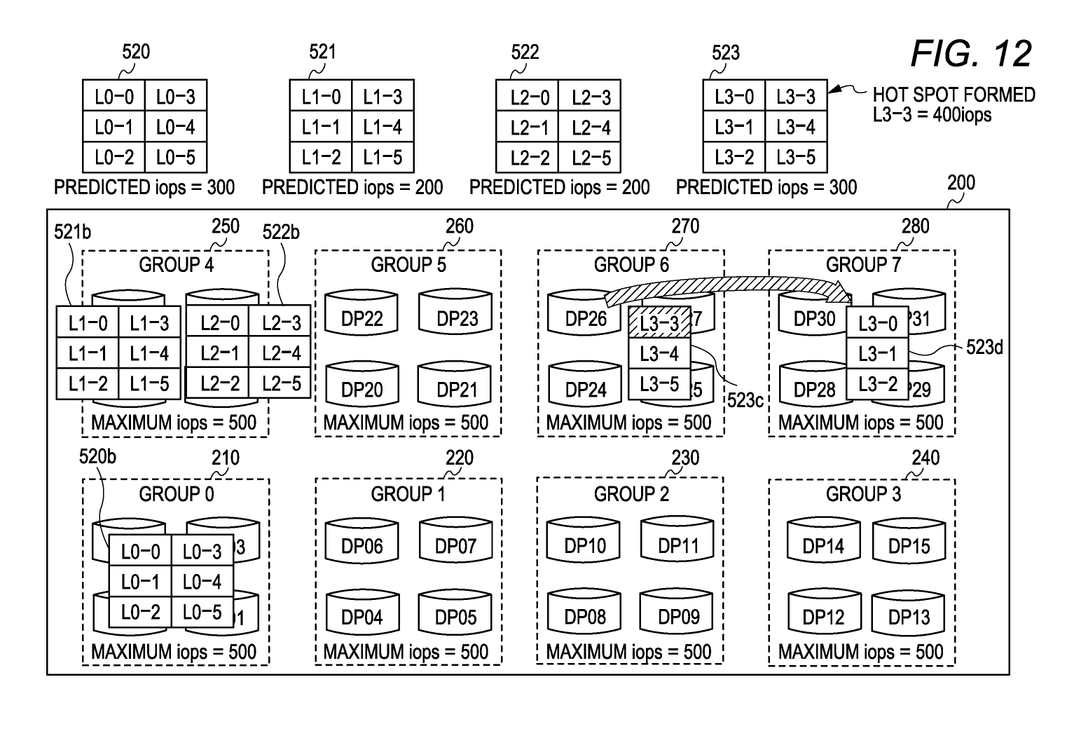

FIG. 12 illustrates a reallocation process to be performed when a hot spot is detected.

FIG. 12 illustrates a situation in which a hot spot is formed during an operation in the allocation state illustrated in FIG. 10. In this example, the packet analyzer 400 transmits a notification that a hot spot is detected at the logical slice L3-3 of the logical volume LVOL3(523), and the size (the iops) of the hot spot is “400”.

Upon receipt of the notification, the allocation controller 110 determines to which DP group the reported hot spot belongs. In this example, the DP group 6(270) is determined to have the hot spot. The allocation controller 110 then reads the maximum iops value and the predicted iops value of the group 6(270) from the group management information 1100 and the group management information (the allocation information) 1200. In this example, the maximum iops value (=500) and the predicted iops value (=300) of the DP group 6 are obtained. A check is then made to determine whether the access load on the DP group 6(270) exceeds the maximum iops value (=500) of the DP group 6 due to the load of the hot spot. Since the predicted iops value of the logical volume LVOL3(523) is “300”, the sum of predicted iops value of the logical volume LVOL3(523) and the load of the hot spot (iops=400) caused at the logical slice L3-3 is determined to exceed the maximum iops value of the DP group 6. Here, the check may be made, with the load on the logical slice L3-3 in the predicted iops value being subtracted.

Since the load on the DP group 6(270) is determined to exceed the maximum iops value due to the hot spot, the slices that belong to the same DP group and do not have a hot spot are moved to another DP group. In this example, the slices are divided into a slice set 523c (L3-3, L3-4, and L3-5) that contains the hot spot, and a slice set 523d (L3-0, L3-1, and L3-2) that does not contain a hot spot. The DP group 7(280) is newly allocated to the logical volume LVOL3(523), and the slice set 523d is moved to the DP group 7(280).

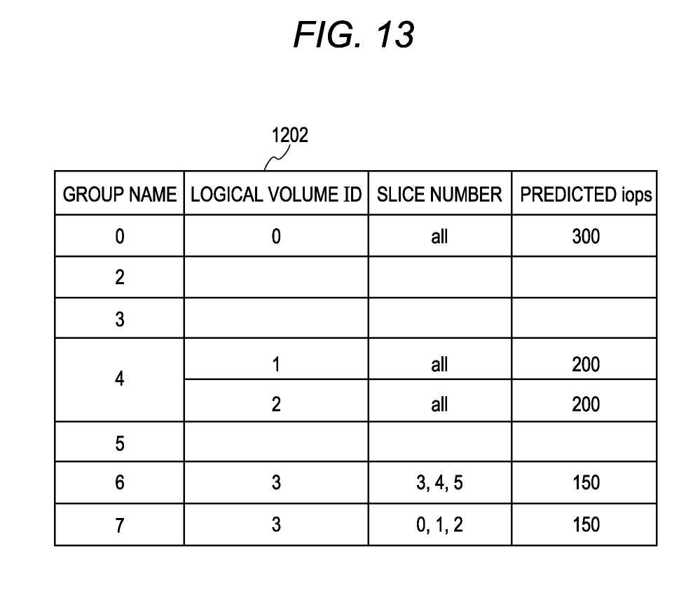

FIG. 13 illustrates the group management information (the allocation information) observed after a reallocation process is performed due to a hot spot.

The group management information (the allocation information) 1202 illustrates the state observed where a reallocation process is performed in the situation illustrated in the group management information 1201 illustrated in FIG. 11.

The group management information 1202 indicates that the logical slices L3-3, L3-4, and L3-5 of the logical volume LVOL3(523) are allocated to the DP group 6(270). The predicted iops value of the DP group 6 is 150, which is half the originally predicted iops value (=300). However, the predicted iops values can be set by the manager as desired. The group management information 1202 also indicates that the logical slices L3-0, L3-1, and L3-2 of the logical volume LVOL3(523) are allocated to the DP group 7(280). The other aspects are the same as those of the DP group 6 (270).

In the above description, the allocation controller 110 performs a reallocation process, upon receipt of a hot spot notification from the packet analyzer 400. Alternatively, the allocation controller 110 may obtain observation information from the packet analyzer 400 on a regular basis, and determine whether reallocation is required.

Therefore, the allocation controller 110 monitors the system condition, and checks whether the processing capability is maintained. If the processing capability is not maintained, the allocation controller 110 performs slice reallocation.

When an operation starts, the observation information from the packet analyzer 400 is regularly sent to the control node 100. The packet analyzer 400 captures packets flowing in the network 600, and analyzes the packets in various manners, so as to generate the observation information. For example, the packet analyzer 400 analyzes an input/output request packet (hereinafter referred to as an “IO packet”) that involves an access to a slice. The packet analyzer 400 then sends the observation information that contains the distributions of the iops and io sizes in a given period of time, and the like. The allocation controller 110 analyzes the observation information, and calculates the observed performance values such as the access load. In this manner, the allocation controller 110 analyzes the access characteristics of each logical volume.

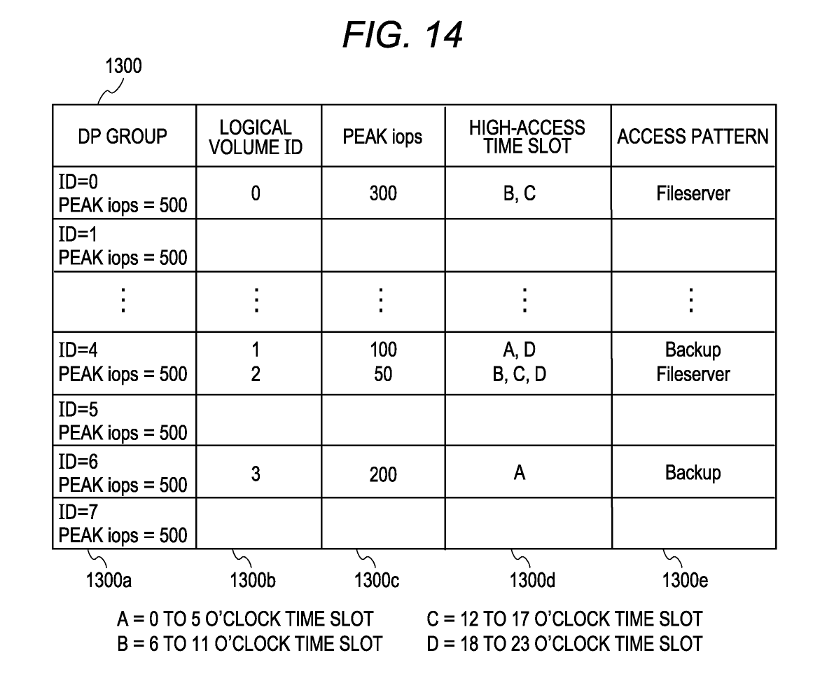

FIG. 14 illustrates an example of access characteristics information that is analyzed based on the observation information.

Here, the access characteristics of each logical volume are represented by the following three points: the “peak iops value”, the “time slot with high access load”, and the “access pattern”. The access characteristics are based on the observation information obtained in the allocation state illustrated in FIG. 10.

The access characteristics information 1300 has the information item columns of a DP group column 1300a, a logical volume ID column 1300b, a peak iops column 1300c, a high access time slot column 1300d, and an access pattern column 1300e.

The IDs of groups formed through a group forming process, and the calculated maximum peak iops values of the respective groups are registered in the DP group column 1300a. The maximum peak iops values are equivalent to the values in the maximum iops column 1100d of the group management information 1100.

The IDs (the identification numbers) of the logical volumes allocated to those DP groups are registered in the logical volume ID column 1300b.

The peak iops values observed in the respective logical volumes are set in the peak iops column 1300c. For example, the peak iops values observed in a certain period of time such as the past one weak or the past one month are recorded.

The iops values measured as observation information are classified into time slots, and the results of a calculation to determine the time slots having high access load are registered in the high-access time slot column 1300d. Here, “high-access load state” is defined as a “state where each iops value detected from the logical volumes maintains a value equal to or higher than half the peak value in the time slot”. In FIG. 14, A represents the time slot of 0 to 5 o'clock (0:00 to 5:59, the same applying to the other time slots), B represents the time slot of 6 to 11 o'clock, C represents the time slot of 12 to 17 o'clock, and D represents the time slot of 18 to 23 o'clock.

One of the two kinds of access characteristics determined based on the io size distribution measured as the observation information is registered in the access pattern column 1300e. A Fileserver type is an access pattern that is often used for accessing a file server, and involves a read/write request of a relatively small size. A Backup type is an access pattern that is often used for making an access for saving data in a backup process, and involves a read/write request of a relatively large size. The size of the request contained in each read/write request packet is analyzed, and the io size distribution in a given period of time is obtained. Based on the io size distribution, a check is made to determine the type of access pattern. These procedures are carried out by the packet analyzer 400, and the allocation controller 110 may receive only the results.

For example, the top row indicates that the logical volume “LVOL0” is allocated to the DP group 0, and the peak iops value of “300” is observed. The high-access time slots of the logical volume are the time slot B (6 to 11 o'clock) and the time slot C (12 to 17 o'clock), and there are many accesses made in the daytime. The access pattern is of the Fileserver type.

A reallocation process can be performed based on the access characteristics of the logical volumes obtained by analyzing the observation information. Each of the characteristic aspects is now described.

The largest access load caused in each logical volume can be seen from the peak iops column 1300c. By comparing the peak iops value with the maximum iops value of the DP group to which the logical volume is allocated, a prediction can be made about whether response deterioration or the like is caused when the access load of the logical volume of the DP group reaches the maximum value. When the peak iops value exceeds the maximum iops value of the corresponding DP group, a hot spot is considered to exist. In this manner, a hot spot can be detected, without a notification from the packet analyzer 400.

When the peak iops value of a logical volume exceeds the maximum iops value of the corresponding DP group, a reallocation process is carried out as in a case where a hot spot is detected.

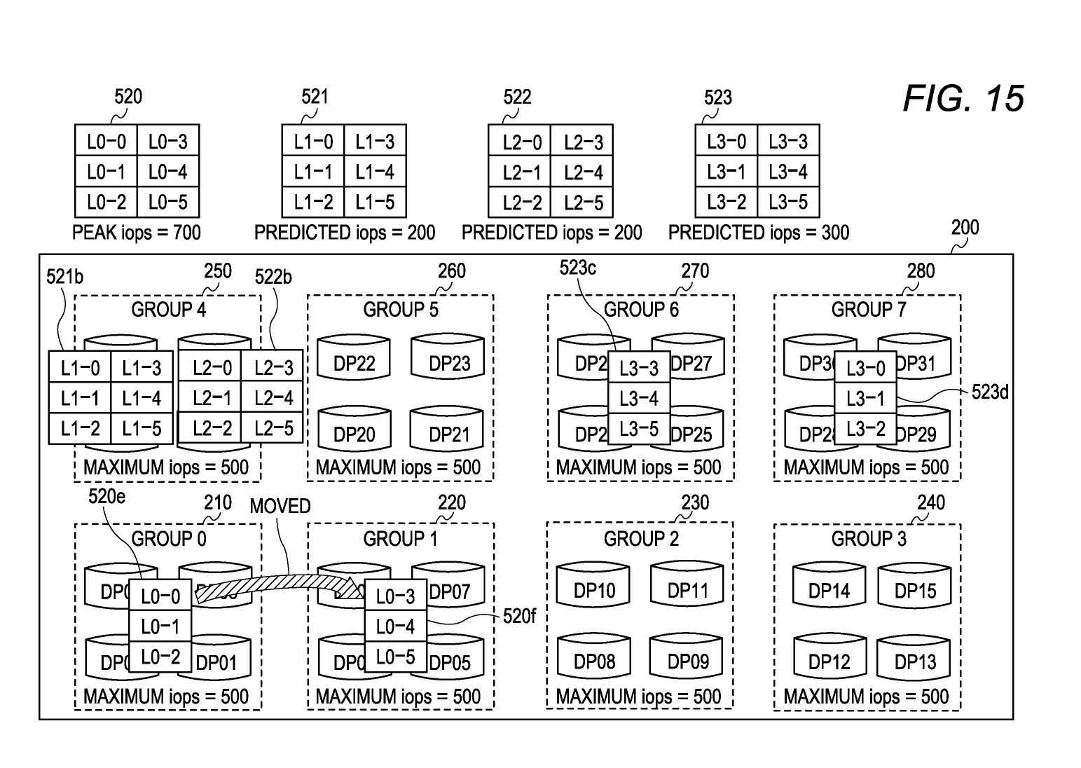

FIG. 15 illustrates a reallocation process performed when a peak iops value exceeds the corresponding maximum iops value.

In this example, the peak iops value of the logical volume LVOL0(520) is observed as “700” during an operation in the allocation state illustrated in FIG. 12.

The control node 100 compares the peak iops value (iops=700) of the logical volume LVOL0(520) based on observation with the maximum iops value (iops=500) of the corresponding DP group 0(210). Since the peak iops value exceeds the maximum iops value, a new DP group is allocated to the logical volume LVOL0(520), and some of the logical slices of the logical volume LVOL0(520) are moved to the newly allocated DP group. In this example, the logical volume LVOL0(520) is divided into a slice set 520e (L0-0, L0-1, and L0-2) and a slice set 520f (L0-3, L0-4, and L0-5). The slice set 520f is moved to the new DP group 1(220).

As described above, when an observed peak iops value exceeds the maximum iops value of the allocated DP group, at least part of the logical volume is moved to another DP group. In this manner, the peak iops values in both the DP group first allocated to the logical volume and the DP group newly allocated to the logical volume can be made smaller than the maximum iops values. Accordingly, even if access load becomes too large due to some trouble, reallocation is performed to divide the access load, and the desired processing capability can be maintained.

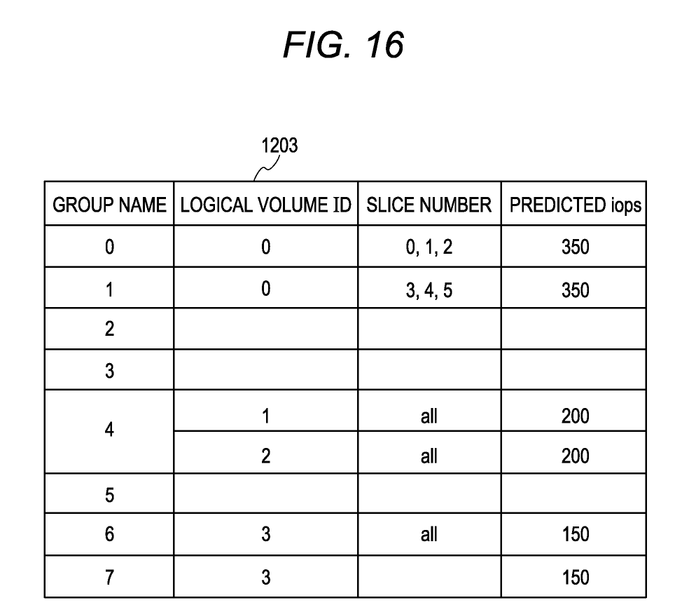

FIG. 16 illustrates the group management information observed after the reallocation process performed when the peak iops value exceeds the maximum iops value.

The group management information (the allocation information) 1203 illustrates the state observed after the reallocation process illustrated in FIG. 15 is performed in the state represented by the group management information 1202 illustrated in FIG. 13.

The logical volume LVOL0 is divided between the DP group 0 and the DP group 1. In this example, the logical slices L0-0, L0-1, and L0-2 of the logical volume LVOL0 are allocated to the DP group 0. Also, the logical slices L0-3, L0-4, and L0-5 of the logical volume LVOL0 are allocated to the DP group 1. Although the predicted iops value is 350, which is half the observed peak iops value (iops=700), a manager can set each predicted iops value as needed.

Since only one logical volume is allocated to a DP group having a peak iops value larger than the maximum iops value, the logical volume is divided in this example. However, in a case where two or more logical volumes are already allocated to one DP group, one of the logical volumes is first moved to another DP group.

Referring back to FIG. 14, explanation of the access characteristic aspects is resumed.

The time slots having high access load in each logical volume can be seen from the high-access time slot column 1300d. If logical volumes having different high-access time slots are allocated to the same DP group, response deterioration due to overlapping peak access time can be reduced, if not avoided.

For example, the logical volume LVOL0 (peak iops=300) is allocated to the DP group 0. Since the maximum iops value of the DP group is 500, the logical volume LVOL1 (peak iops=100) or the logical volume LVOL2 (peak iops=100) can also be allocated to the DP group 0. In this case, the logical volume LVOL1 that has different high-access time slots from the logical volume LVOL0 should be selected. In this manner, the peak access time slots do not overlap, and a too large access load can be reduced, if not prevented.

The type of pattern of access that is often observed in accesses to each logical volume can be seen from the access pattern column 1300e. In general, higher processing efficiency can be achieved, if the io sizes of read/write requests are substantially the same in one DP group. Therefore, where logical volumes are allocated to one DP group, the logical volumes should have the same access patterns, so as to achieve higher processing efficiency.

For example, the logical volume LVOL0 (access pattern=Fileserver) is allocated to the DP group 0. Since the maximum iops value of the DP group is 500, the logical volume LVOL1 (peak iops=100) or the logical volume LVOL2 (peak iops=100) can also be allocated to the DP group 0. In this case, the logical volume LVOL2 that has the Fileserver-type access pattern should be selected over the logical volume LVOL1 that has the Backup-type access pattern. In this manner, higher access processing efficiency can be achieved.

As described above, the system access state is observed even after an allocation process, and a reallocation process is performed based on the observation results. In this manner, the processing capability can be continually maintained. Also, reallocation is performed based on the analyzed access characteristics, so as to achieve even higher processing efficiency.

Next, the allocation control method to be implemented by the allocation control device 10 is described with reference to a flowchart.

First, a process to be performed when the power supply starts is described. In an initialization process, DPs are divided into groups, if DP groups are not formed yet.

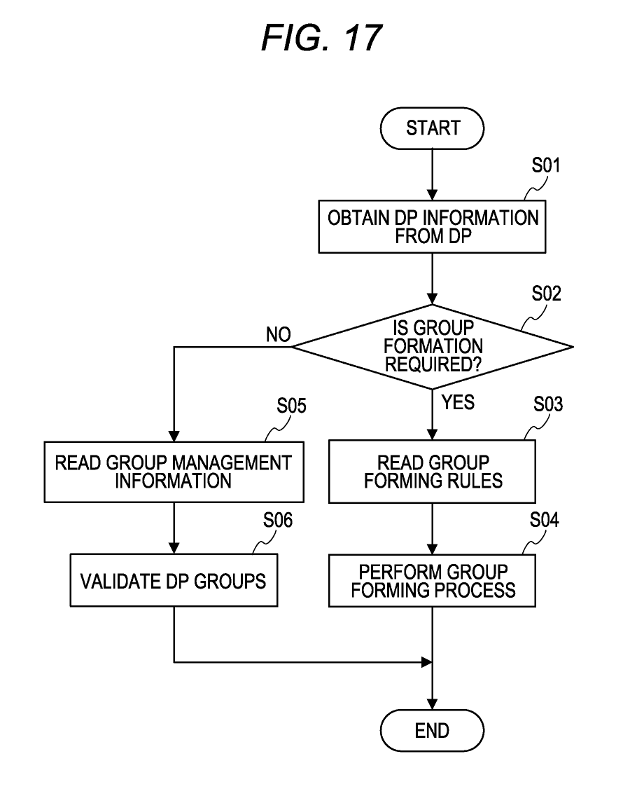

FIG. 17 is a flowchart illustrating the procedures to be carried out after the power supply starts.

When the power supply starts, the processing is started. Before this point, the group forming rules for forming DP groups should be defined, and be stored in the rule storing unit 120.

[Step S01] The DP information (such as the peak iops value, the RAID type, and the like) is obtained from each DP in the DP set 200. Alternatively, the information may be automatically sent from the DPs at the time of start-up. The obtained information is registered in the DP management information 1000.

[Step S02] The group management information 1200 is read out, and a check is made to determine whether groups have been formed in the DP set 200. If groups are not formed, the processing moves on to step S03. If groups are already formed, the processing moves on to step S05.

[Step S03] If groups are not formed yet, a group forming process is started. The group forming rules stored in the rule storing unit 120 are read out. The group forming rules define the conditions for forming a group, such as the number of DPs in each one group, the maximum iops value, and the RAID type.

[Step S04] According to the group forming rules read out at step S03, the DP set 200 is divided into groups. If the rules specify that a group is formed with four DPs, each four DPs form one group. If the rules specify that each group has the iops value of 600, groups are formed so that the total iops value of the DPs in each group exceeds 600. If the rules specify RAID units, groups are formed so that each group contains DPs of the same RAID type. Those rules may be set in combination. The information about the formed groups is registered in the group management information 1100. The group management information 1100 includes not only the identification information about the DPs belonging to the respective groups, but also the maximum iops value calculated for each group. After the group formation is completed, the processing comes to an end.

[Step S05] If groups are already formed, the group structure information is read out from the group management information 1100.

[Step S06] After the normality of the DPs registered in the DP groups is confirmed, the DP groups are validated, and logical volume allocation is enabled. The normality of each DP is checked by determining whether a response can be received from the DP. After the DP groups are validated, the processing comes to an end.

If groups are not formed yet, DPs are divided into groups based on the group forming rules through the above described procedures, and the DP groups are made usable. If groups are already formed, the DP groups registered based on the group management information are validated, and are made usable.

In the processing thereafter, a logical volume slice allocation process is performed on the group basis.

Next, the logical volume slice allocation process is described. The logical volume slice allocation is performed for each group.

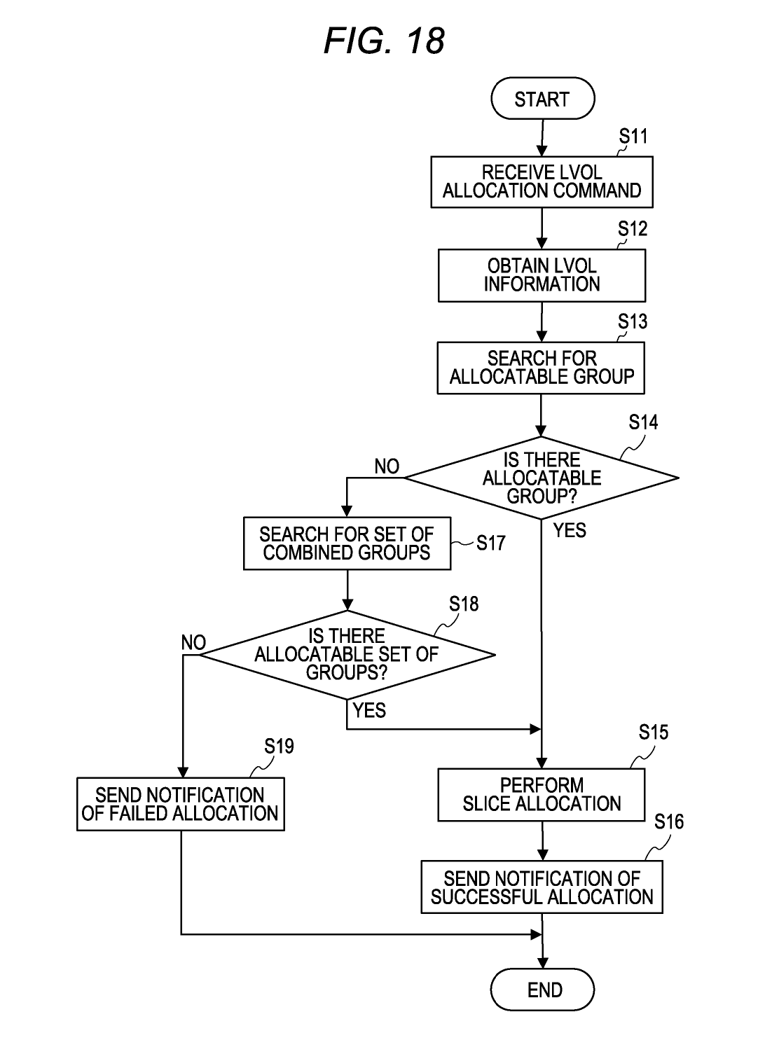

FIG. 18 is a flowchart illustrating the procedures for allocating slices to logical volumes. An instruction to allocate slices to a logical volume (denoted by LVOL in FIG. 18) is received from the system manager via the management node 700, and the processing is started.

[Step S11] A logical volume allocation command is received from the management node 700. The logical volume allocation command contains the identification information about a subject logical volume.

[Step S12] The logical volume information about the subject logical volume contained in the command obtained at step S11 is obtained. The logical volume information may be obtained from the access node managing the subject logical volume, for example. The logical volume information contains at least the capacity and the peak iops value of the subject logical volume. The peak iops value is determined by the system manager or the like, according to the past performance.

[Step S13] In a case where the allocation rule is defined in the rule storage unit 120, an allocatable group is searched for, based on the allocation rule. In a case where there are no particular rules, the capacity and the peak iops value of the subject logical volume obtained at step S12 are compared with the capacity and the maximum iops value of the physical storage areas in each group, and an allocatable group is searched for. Here, the group to be searched for should have the physical storage areas with greater capacity than the capacity of the subject logical volume, and have its maximum processing capability higher than the peak iops value of the subject logical volume.

[Step S14] A check is made to determine whether there is a group that satisfies the search conditions at step S13. If there is such a group, the processing moves on to step S15. If not, the processing moves on to step S17.

[Step S15] If a group or groups that satisfy the above conditions are detected, slices of DPs belonging to the detected group or groups are allocated to the logical slices of the subject logical volume. Here, initial slice allocation is performed, e.g., in a round-robin fashion, so that the logical slices are evenly divided among the DPs belong to the group or groups. The initial allocation is subject to subsequent, dynamic reallocation if deemed appropriate.

[Step S16] A notification of successful allocation is sent to the management node 700 that has made the allocation request, and the processing comes to an end.

[Step S17] If a group that satisfies the conditions is not detected, DP groups are combined, and the searching procedure is carried out. The total capacity and the total maximum iops values of each set of combined groups are used as the capacity and the maximum iops value of the set of combined groups, and the same searching procedure as that of step S13 is carried out.

[Step S18] A check is made to determine whether there is a set of groups that satisfies the search conditions at step S17. If there is a set of groups that satisfies the search conditions, the processing moves on to step S15. If not, the processing moves on to step S19.

[step S19] A notification of failed allocation is sent to the management node 700 that has made the allocation request, and the processing comes to an end.

By carrying out the above procedures, a DP group or a set of DP groups is allocated to a subject logical volume, and slice allocation is performed, with all the slices of the allocated DP group or the allocated set of DP groups being the maximum area. Accordingly, even if a hot spot or the like is formed in a logical volume, the logical volumes allocated to the other groups are not affected.

Next, a reallocation process is described, such a reallocation may be performed to revise the initial allocation when reallocation is deemed appropriate based on observation information.

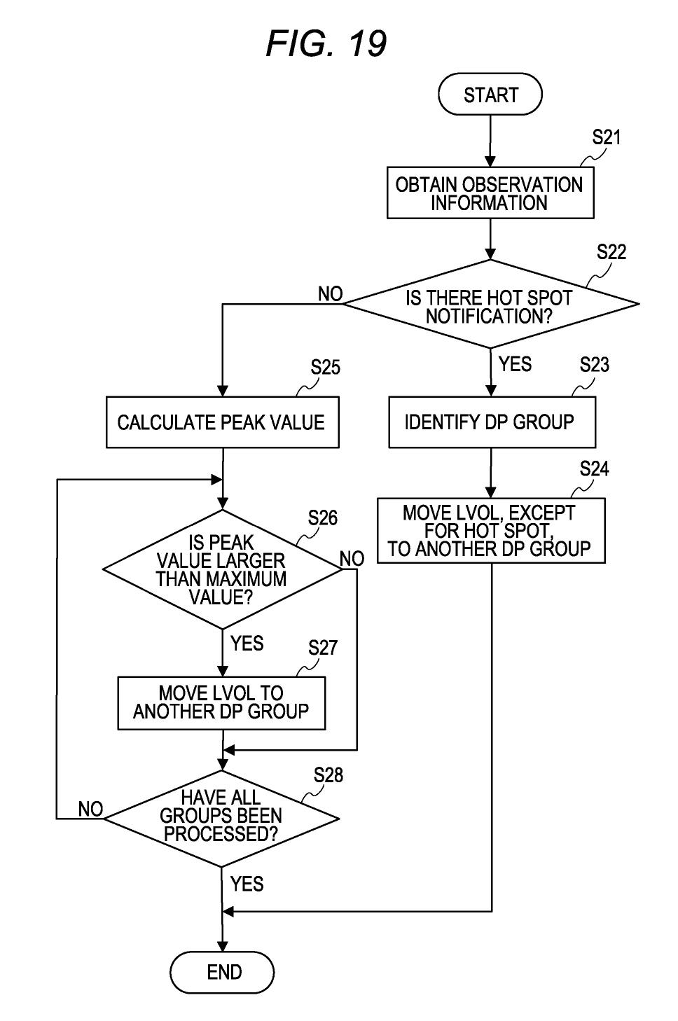

FIG. 19 is a flowchart illustrating the procedures in the reallocation process.

The observation information is obtained from the packet analyzer 400, and the processing is started.

[Step S21] The observation information is obtained from the packet analyzer 400. Not only the observation data transmitted on a regular basis, but also a notification of a hot spot detected by the packet analyzer 400 is transmitted as the observation information from the packet analyzer 400.

[Step S22] A check is made to determine whether the observation information obtained at step S21 is a notification of a hot spot. A hot spot notification contains the information about the logical volume and the slice number at which the hot spot is detected, and the size (iops) of the hot spot. If the observation information is a hot spot notification, the processing moves on to step S23. If not, the processing moves on to step S25.

[Step S23] If the obtained observation information is a hot spot notification, the corresponding DP group is identified based on the notification. For example, the DP group corresponding to the logical volume mentioned in the notification is extracted by searching the group management information (the allocation information) 1200.

[Step S24] The size (iops) of the hot spot contained in the hot spot notification is compared with the maximum iops value of the group identified at step S23. If the hot spot load is larger, reallocation is performed. In the reallocation, e.g., the logical slices allocated to the slices other than the hot spot in the group identified at step S23 are moved to slices in another DP group. When the access load decreases at least by the amount equivalent to the slices to be moved, slices are moved so that the peak iops value (the value obtained by subtracting the moved slices from the iops value observed at the time of the hot spot formation) of this group does not exceed the maximum iops value. When the moving is completed, the processing comes to an end.

[Step S25] If the obtained observation information is not a hot spot notification, the peak iops value of each group is calculated from the observation information.

[Step S26] The peak iops value obtained at step S25 is compared with the maximum iops value of the DP group. If the peak iops value is higher than the maximum iops value of the DP group, the processing moves on to step S27. If the peak iops value is not higher than the maximum iops value, the processing moves on to step S28.

[Step S27] When the peak iops value is higher than the maximum iops value of the DP group, the logical slices allocated to slices in the same DP group are moved to slices of another DP group. When the access load decreases at least by the amount equivalent to the slices to be moved, slices are moved so that the peak iops value of this group does not exceed the maximum iops value. Instead of some of the slices, the entire logical volume may be moved. Particularly, in a case where two or more logical volumes are allocated to one DP group, one of the logical volumes is moved.

[Step S28] A check is made to determine whether all the DP groups have been processed. If not, the processing returns to step S26, and unprocessed DP groups are processed. Where all the DP groups have been processed, the processing comes to an end.

By carrying out the above procedures, the slices allocated to a DP group are moved to another DP group when access load higher than the maximum processing capability of the DP group is applied. In this manner, the access load of each allocated logical volume is controlled not to exceed the maximum processing capacity of each corresponding DP group.

In accordance with the above-described embodiment, a logical volume dynamic allocation process is performed, with the maximum range being the physical storage areas of the storage management devices belonging to the selected group. Accordingly, influence of performance degradation such as a response delay of a logical volume is enclosed within the group, and the processing capability of the logical volumes allocated to the other groups can be maintained regardless of the degradation.

The above processing functions can be embodied by a computer. In such a case, a program in which the processing contents of the functions expected in an allocation control device are written is provided. By executing the program with a computer, the above processing functions are realized by the computer. The program having the processing contents written therein can be recorded on a computer-readable recording medium.

In a case where the program is distributed, portable recording media such as DVDs (Digital Versatile Discs) and CD-ROMs (Compact Discs) having the program recorded thereon are put on the market. Alternatively, the program may be stored in a storage device of a server computer, and may be transferred from the server computer to other computers via a network.

Each computer that executes programs stores a program recorded on a portable recording medium or a program transferred from the server computer, into its own storage device. The computer then reads the program from its own storage device, and performs processing in accordance with the program. Alternatively, each computer may read a program directly from a portable recording medium, and perform processing in accordance with the program. Also, every time a program is transferred from the server computer, each computer may perform processing in accordance with the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium comprising an allocation control program encoded thereon, the allocation control program containing instructions for performing a method execution of which by a computer facilitates allocating logical volumes to physical storage areas managed by a set of storage management devices, the method including:
dividing the storage management devices into groups, based on grouping factors that contain at least one of information about the physical storage areas managed by each of the storage management devices, characteristics regarding performance of the storage management devices and corresponding storage devices, respectively, and information about rules for forming groups;
generating group management information about each group based on the grouping factors corresponding to storage management devices belonging to the group, the group management information indicating maximum processing capability information about the group;
obtaining logical volume information about a subject logical volume to be allocated to the physical storage areas, the logical volume information indicating the capacity of the subject logical volume and a predicted capability value of the subject logical volume with respect to the specific performance;
acquiring the physical storage areas to which the subject logical volume is to be allocated, based on the logical volume information and the group management information;
selecting one of the groups for which the maximum processing capability is higher than the predicted capability value of the subject logical volume; and
allocating divisional areas of the subject logical volume to the physical storage areas in the selected group.

2. The computer-readable recording medium according to claim 1, wherein the computer-executed method further includes:
initially allocating the divisional areas of the subject logical volume evenly among the storage management devices belonging to the group selected for the subject logical volume.

3. The computer-readable recording medium according to claim 1, wherein the predicted capability value of the logical volume is calculated based on empirically derived processing capability of the logical volume.

4. The computer-readable recording medium according to claim 1, computer-executed method further includes:
calculating maximum access capacity of the group, based on the processing capability information about access processing capability of the storage management devices belonging to the group;
obtaining a predicted capability value about access processing capability desired for the subject logical volume;
comparing the predicted capability value of the subject logical volume with the maximum access capacity of the group; and
selecting the group that has the maximum access capacity higher than the access processing capability desired for the subject logical volume.

5. The computer-readable recording medium according to claim 1, wherein the computer-executed method further includes:
identifying the group and the logical volume corresponding to a specific physical storage area when an observation unit observing access processing states of the storage management devices sends a notification that an access concentration is detected from the specific physical storage area, the group and the logical volume being identified based on the group management information;
newly selecting the group that is capable of acquiring the physical storage areas to which the logical volume is to be properly reallocated; and
reallocating some or all of the divisional areas of the logical volume to unallocated ones of the physical storage areas in the selected group.

6. The computer-readable recording medium according to claim 5, wherein the computer-executed method further includes:
obtaining observation information generated by the observation unit observing the access processing states of the storage management devices;
sorting the observation information for each of the groups;
calculating an observation value of each of the groups with respect to the specific performance based upon the observation information about each of the groups; and
associating the observation value with the group management information,
comparing the observation value of each group with the maximum processing capability of the group calculated based on the information about the specific performance of the storage management devices defined by the grouping factors and the storage devices corresponding to the storage management devices; and
reallocating the logical volume allocated to the group, when the observation value of the group exceeds the maximum processing capability of the group.

7. The computer-readable recording medium according to claim 6, wherein the computer-executed method further includes:
determining a number of observed accesses in the group, based on the number of times access processing is performed in the group in a period of time;
calculating a maximum access capacity of the group based on the grouping factors specifying the access processing capacity of the storage devices;
comparing the number of observed accesses with the maximum access capacity of the group; and
reallocating the logical volume allocated to the group, when the number of observed accesses exceeds the maximum access capacity of the group.

8. The computer-readable recording medium according to claim 6, wherein the computer-executed method further includes:
analyzing a tendency of accesses to the logical volume, based on the observation information, to generate access characteristics thereof;
selecting the group for the subject logical volume, based on the access tendency of the subject logical volume; and
allocating the divisional areas of the subject logical volume to the physical storage areas in the selected group.

9. The computer-readable recording medium according to claim 8, wherein the computer-executed method further includes:
dividing accesses detected from each group into time slots;
analyzing the tendency of accesses in each of the time slots, based on the observation information, and
allocating a set of logical volumes to the same group, the logical volumes having different access tendencies from each other in the respective time slots.

10. The computer-readable recording medium according to claim 8, wherein the computer-executed method further includes:
classifying accesses detected from each group into access patterns in accordance with processing sizes;
analyzing the tendency of accesses of the respective access patterns, based on the observation information, and
allocating a set of logical volumes to the same group, the logical volumes having the same access patterns.

11. An allocation control device for allocating logical volumes to physical storage areas managed by a set of storage management devices, the allocation control device comprising:
a memory that stores grouping factors that contain at least one of information about the physical storage areas managed by each of the storage management devices, characteristics regarding performance of the storage management devices and corresponding storage devices, respectively, and information about rules for forming groups;
a group forming unit operable to do at least the following,
divide the storage management devices into groups based on the grouping factors,
generate group management information about each group based on the grouping factors corresponding to storage management devices belonging to the group, the group management information indicating maximum processing capability about the group, and
store the group management information into the memory; and
an allocating unit operable to do at least the following,
obtain logical volume information about a subject logical volume to be allocated to the physical storage areas, the logical volume information indicating the capacity of the subject logical volume and a predicted capability value of the subject logical volume with respect to the specific performance;
acquire the physical storage areas to which the subject logical volume is to be allocated, based on the logical volume information and the group management information;
select one of the groups for which the maximum processing capability is higher than the predicted capability value of the subject logical volume; and
allocate divisional areas of the subject logical volume to the physical storage areas in the selected group.

12. A computer-implemented allocation control method for allocating logical volumes to physical storage areas managed by a set of storage management devices, the method comprising:
dividing the storage management devices into groups, based on grouping factors that contain at least one of information about the physical storage areas managed by each of the storage management devices, characteristics regarding performance of the storage management devices and corresponding storage devices, respectively, and information about rules for forming groups;
generating group management information about each group based on the grouping factors corresponding to storage management devices belonging to the group, the group management information indicating maximum processing capability about the group;
obtaining logical volume information about a subject logical volume to be allocated to the physical storage areas, the logical volume information indicating the capacity of the subject logical volume and a predicted capability value of the subject logical volume with respect to the specific performance;
acquiring the physical storage areas to which the subject logical volume is to be allocated, based on the logical volume information and the group management information;
selecting one of the groups for which the maximum processing capability is higher than the predicted capability value of the subject logical volume; and
allocating divisional areas of the subject logical volume to the physical storage areas in the selected group.

13. The method according to claim 12, further including:
initially allocating the divisional areas of the subject logical volume evenly among the storage management devices belonging to the group selected for the subject logical volume.

14. The method according to claim 12, wherein the predicted capability value of the logical volume is calculated based on empirically derived processing capability of the logical volume.

15. The method according to claim 12, further including:
calculating maximum access capacity of the group, based on the processing capability information about access processing capability of the storage management devices belonging to the group;
obtaining a predicted capability value about access processing capability desired for the subject logical volume;
comparing the predicted capability value of the subject logical volume with the maximum access capacity of the group; and
selecting the group that has the maximum access capacity higher than the access processing capability desired for the subject logical volume.

16. The method according to claim 12, further including:
identifying the group and the logical volume corresponding to a specific physical storage area when an observation unit observing access processing states of the storage management devices sends a notification that an access concentration is detected from the specific physical storage area, the group and the logical volume being identified based on the group management information;
newly selecting the group that is capable of acquiring the physical storage areas to which the logical volume is to be properly reallocated; and
reallocating some or all of the divisional areas of the logical volume to unallocated ones of the physical storage areas in the selected group.

17. The method according to claim 16, further including:
obtaining observation information generated by the observation unit observing the access processing states of the storage management devices;
sorting the observation information for each of the groups;
calculating an observation value of each of the groups with respect to the specific performance based upon the observation information about each of the groups; and
associating the observation value with the group management information,
comparing the observation value of each group with the maximum processing capability of the group calculated based on the information about the specific performance of the storage management devices defined by the grouping factors and the storage devices corresponding to the storage management devices; and
reallocating the logical volume allocated to the group, when the observation value of the group exceeds the maximum processing capability of the group.

18. The method according to claim 17, further including:
determining a number of observed accesses in the group, based on the number of times access processing is performed in the group in a period of time;
calculating a maximum access capacity of the group based on the grouping factors specifying the access processing capacity of the storage devices;
comparing the number of observed accesses with the maximum access capacity of the group; and
reallocating the logical volume allocated to the group, when the number of observed accesses exceeds the maximum access capacity of the group.

19. The method according to claim 17, further including:
analyzing a tendency of accesses to the logical volume, based on the observation information, to generate access characteristics thereof;
selecting the group for the subject logical volume, based on the access tendency of the subject logical volume; and
allocating the divisional areas of the subject logical volume to the physical storage areas in the selected group.

20. The method according to claim 19, further including:
dividing accesses detected from each group into time slots;
analyzing the tendency of accesses in each of the time slots, based on the observation information, and
allocating a set of logical volumes to the same group, the logical volumes having different access tendencies from each other in the respective time slots.

21. The method according to claim 19, further including:
classifying accesses detected from each group into access patterns in accordance with processing sizes;
analyzing the tendency of accesses of the respective access patterns, based on the observation information, and
allocating a set of logical volumes to the same group, the logical volumes having the same access patterns.
